(19) United States
(12) Patent Application Publication
(10) Pub. No.: US 2006/0115798 A1
(43) Pub. Date: Jun. 1, 2006

(54) Training technology selection tool

(75) Inventors: Robin Amanda Wieckhorst, Winter Springs, FL (US); Karen Elizabeth Mcbee, Winter Springs, FL (US)

Correspondence Address: NAVAL AIR WARFARE CENTER TRAINING SYSTEMS DIVISION, 12350 RESEARCH PARKWAY, TSD 773P, ORLANDO, FL, 32826-3275, US

(73) Assignee: Government of the United States as represented by the Secretary of the Navy

(21) Appl. No.: 11/001,464

(22) Filed: Dec. 1, 2004

(51) Int. Cl. G09B 19/00

(52) U.S. Cl. 434/118

(57) ABSTRACT

An exemplary embodiment of the invention relates to a computer-based program and system for selecting training technology when performance requirements denoted by intellectual skills, physical skills and attitudinal skills are known or can be estimated. The feasible training technologies along with transition and life cycle costs for implementing the feasible technologies are calculated. A means for performing cost sensitivity analysis is provided to examine the solution.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE OR A COMPUTER PROGRAM LISTING APPENDIX SUBMITTED ON A COMPACT DISC

Not Applicable

### BACKGROUND OF THE INVENTION

1. Field of the Invention

This invention relates generally to the field of training and more particularly to training delivery technology selection.

2. Description of the Related Art

Training system design encompasses the identification of feasible media delivery alternatives for each learning objective contained in a course, and then selecting a particular media delivery alternative for presentation to a student. Selection of a particular alternative that is limited by resource availability is not capable of implementation.

In the governmental military training environment, as in the industrial training environment, productivity enhancements are necessitated by efficiency concerns as well as limited resources. Within this environment of efficiency concerns and limited resources, new training delivery technologies are continually being added to traditional training environments such as classroom, on-the-job-training and drills. The judicious selection of the appropriate training delivery technology will allow initial investment costs to be offset by longer term cost avoidances, thereby increasing the return on the investment in training.

A Training Delivery Assessment Model developed by the U.S. Navy at NAVAIR Orlando Training Systems Division was an attempt to implement a structured process for assessing a courses' potential for realizing cost savings through the application of technology. The computer-based process was a performance support system for analysts that comprised three phases. Phase 1 assessed whether the course could be distributed. Phase 2 documented detailed course considerations that were used to determine technology feasibility. Phase 3 applied cost factors so the analysis could rank feasible delivery options.

Unfortunately the logic of the Training Delivery Assessment Model was limited. The software could not analyze situations involving the mix or blending of different technologies. The cost model was further limited because there was no set, detailed procedure for analyzing course content and conducting cost analysis. The parts of the process existed at some level, e.g., formulas, learning taxonomies, instructional systems design principles, etc., but analysts had to pull together from a wide body of knowledge those elements that best applied to the task at hand. Thus, there was a wide range of outcomes even among experienced analysts.

Therefore, there is a need for a quick assessment of the potential for resource savings of the implementation of appropriate training delivery technologies in a given course.

There is an additional need for a standardized high-level process to provide recommendations for feasible technology alternatives that reduce training time.

There is a further need for a high level process that provides identification and screening of the basic available technologies with final selection provided by a rigorous subjective analysis performed by training experts.

There is an additional need for a standardized process that identifies the best mix of learning strategies for a given course.

### BRIEF SUMMARY OF THE INVENTION

It is an object of the invention to identify feasible training alternatives based on specific course training objectives.

It is another object of the invention to compare and select training technology alternatives suitable for training learning objectives.

In one aspect of the invention a computer program is used for selecting one or more training technologies. Training performance attribute queries are provided for determining the performance attributes of the training. Training technology selection logic receives the answers to the queries for selecting the training technology to perform the training and the selected training technology meeting or exceeding the training performance attributes of the training. Cost queries determine the cost of implementing the training technology and cost logic calculates the cost of the training alternatives. A blended analysis is available for performing sensitivity studies using multiple training technologies.

In another aspect of the invention a method of selecting a training technology comprises displaying training performance attribute queries for determining the performance attributes of the training, responding to the training performance attribute queries for determining the performance attributes of the training, applying a training technology selection logic for selecting the training technology to perform the training with the selected training technology meeting or exceeding the training performance attributes of the training, displaying cost queries for determining the cost of implementing the training technology, responding to the cost queries for determining the cost of implementing the training technology, applying a cost logic for calculating the cost of the training and, performing a blended analysis for performing sensitivity studies.

In yet another aspect of the invention a training technology selection tool comprises a means for determining the performance attributes of the training, a means for training technology selection to perform the training, the selected training technology meeting or exceeding the training performance attributes of the training, a means for determining the cost of implementing the training technology, a means for calculating the cost of the training and, a means for performing sensitivity studies.

These and other features and advantages of the present invention may be better understood by considering the following detailed description of certain preferred embodiments. In the course of this description, reference will frequently be made to the attached drawings.

### BRIEF DESCRIPTION OF THE SEVERAL VIEWS OF THE DRAWING

Referring now to the drawing wherein like elements are numbered alike in the several FIGURES:

FIG. 1 is a representative embodiment of a computer for implementing an aspect of the invention;

FIG. 2 is a flowchart of a representative embodiment of the invention showing the relationship between phase I and phase II;

FIG. 3A-C is a flowchart of the logic of a representative embodiment of the invention illustrating the selection of training technologies;

FIG. 4, SH. 1-6 illustrates the questions in one embodiment of the invention;

FIG. 5 illustrates the training technologies available for selection in one embodiment of the invention;

FIG. 6, SH 1-4 illustrates the additional questions in one embodiment of the invention;

FIG. 7-13 illustrate the formulae for performing a cost analysis for each of the training technologies in one embodiment of the invention;

FIG. 14, SH 1-3 illustrates the formulae for performing a blended analysis in one embodiment of the invention;

FIG. 15 illustrates the initial screen for performing an analysis in one embodiment of the invention;

FIG. 16, SH. 1-4 illustrate the query screens for performing an analysis in one embodiment of the invention;

FIG. 17 illustrates the report screen for performing an analysis in one embodiment of the invention;

FIG. 18, SH 1-7 illustrates a typical cost report in one embodiment of the invention;

FIG. 19 illustrates a table of hours for IMI conversion for performing a blended analysis in one embodiment of the invention;

FIG. 20 illustrates a typical report calculated from the blended analysis input in one embodiment of the invention; and,

FIG. 21-22 illustrate typical reports in one embodiment of the invention.

### DETAILED DESCRIPTION OF THE INVENTION

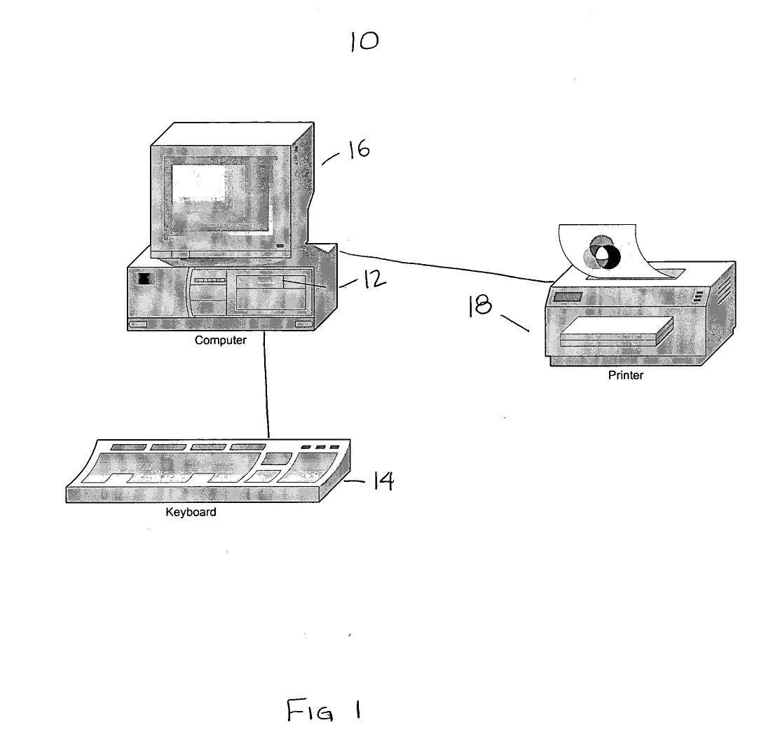

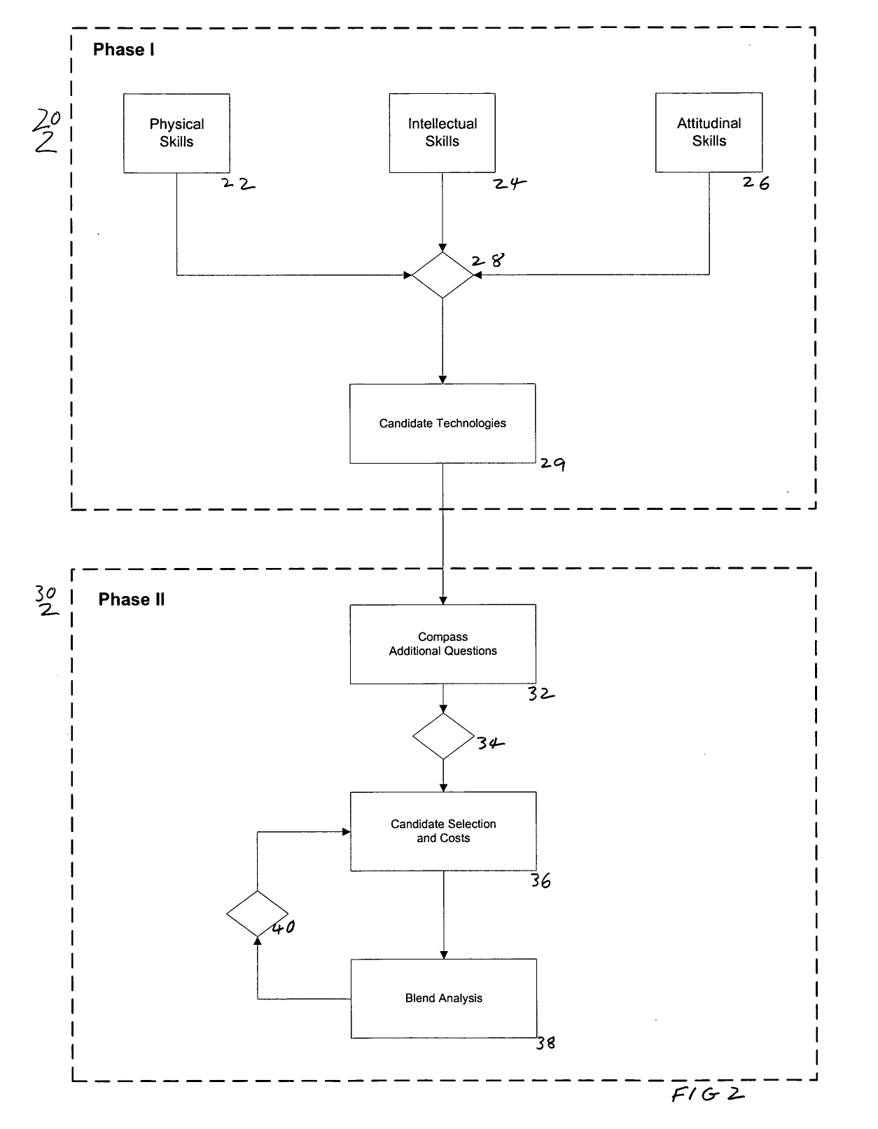

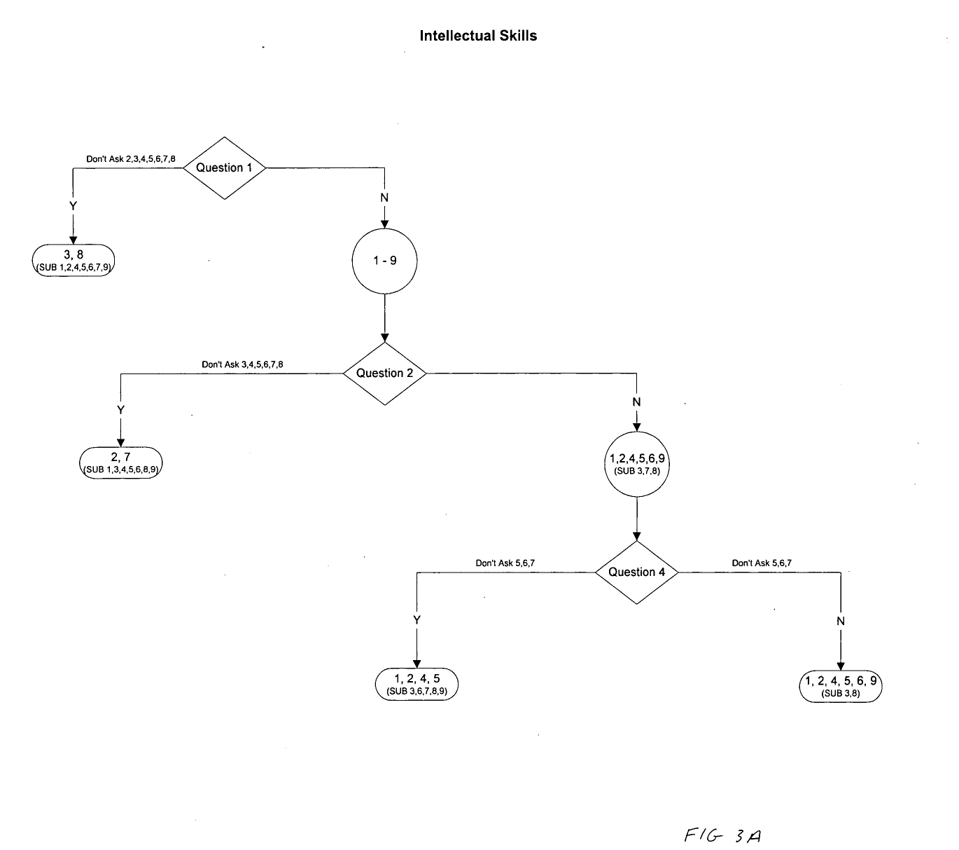

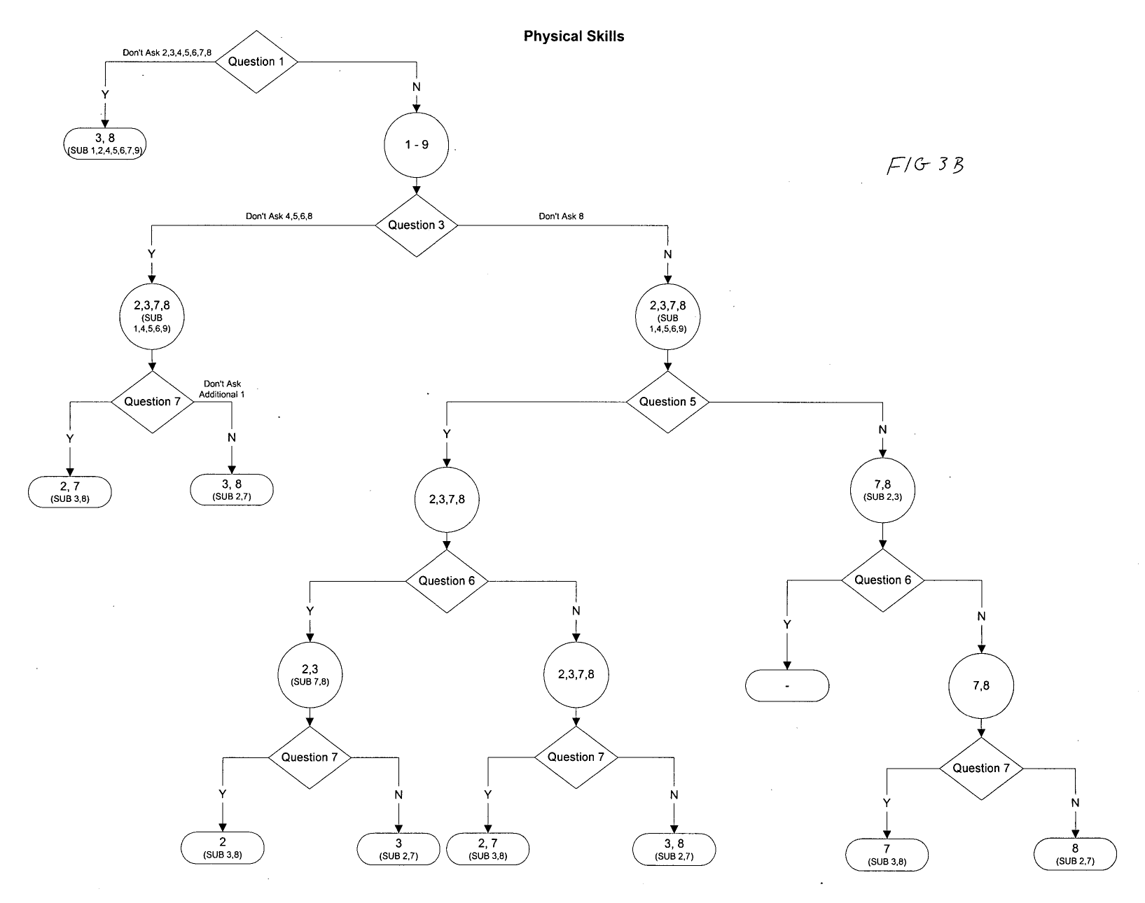

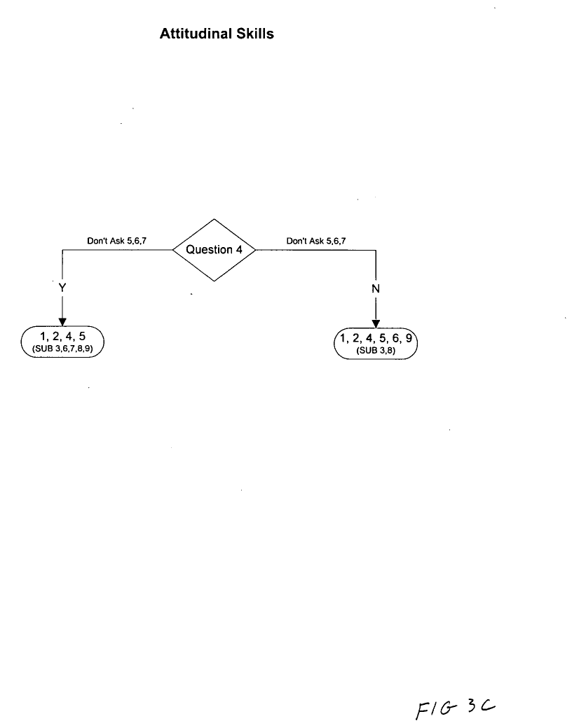

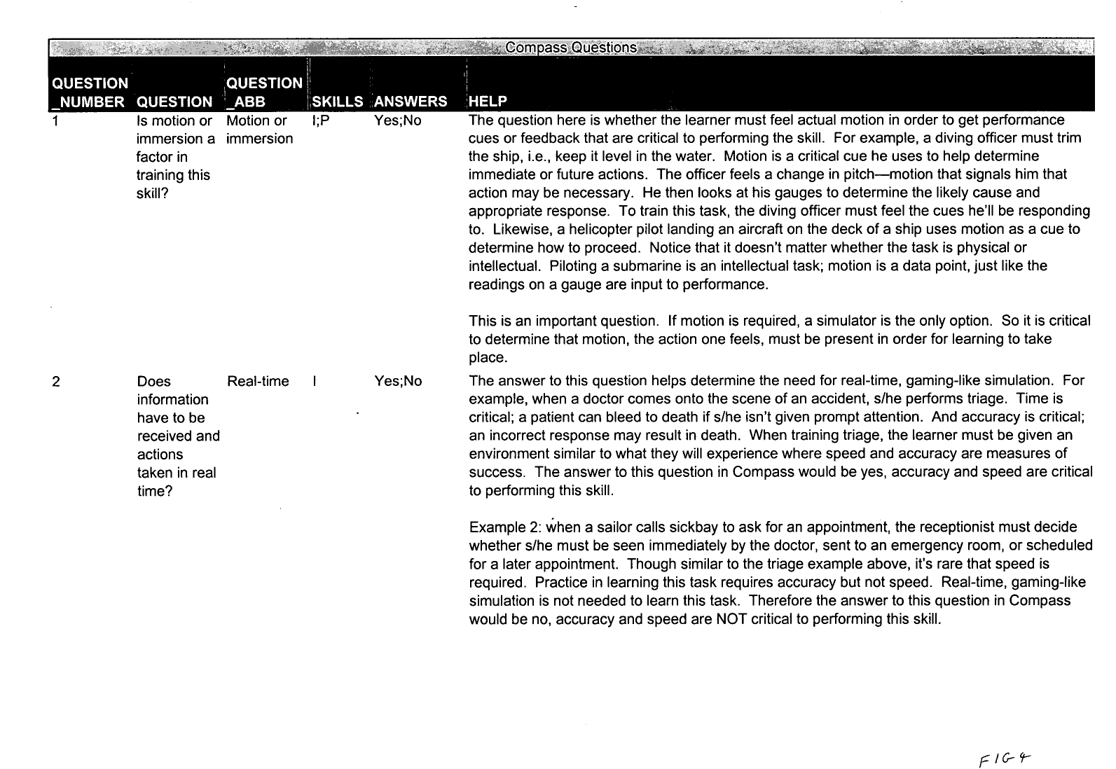

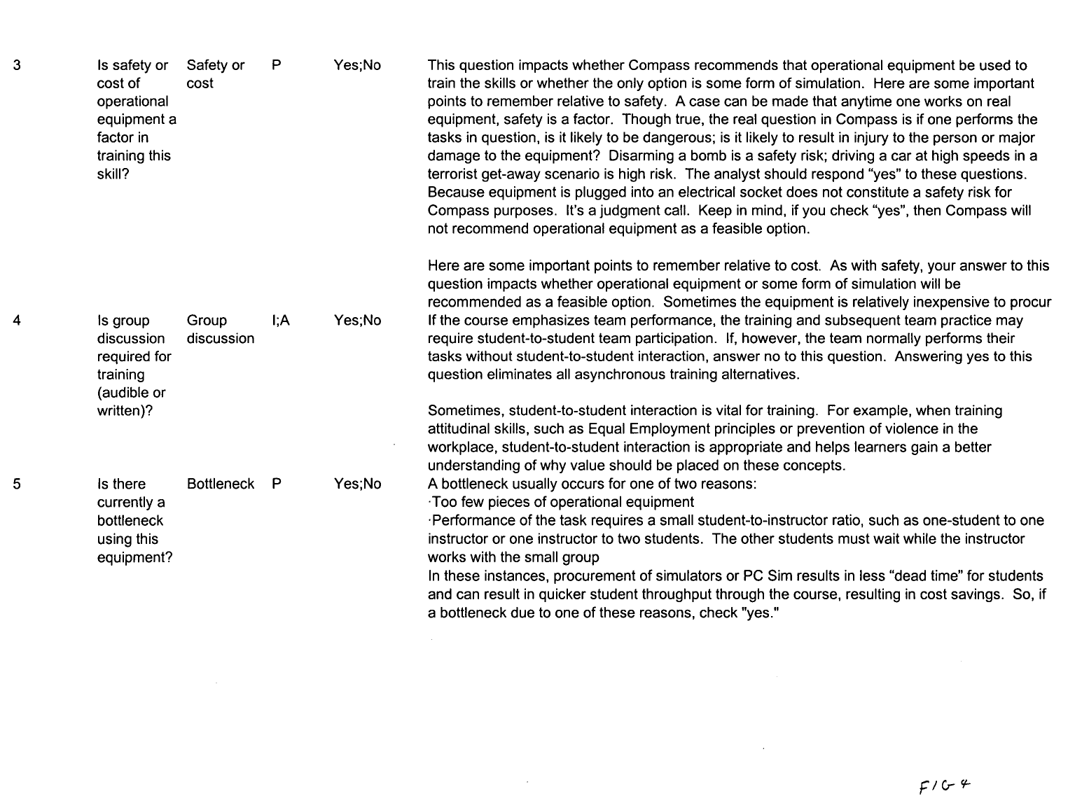

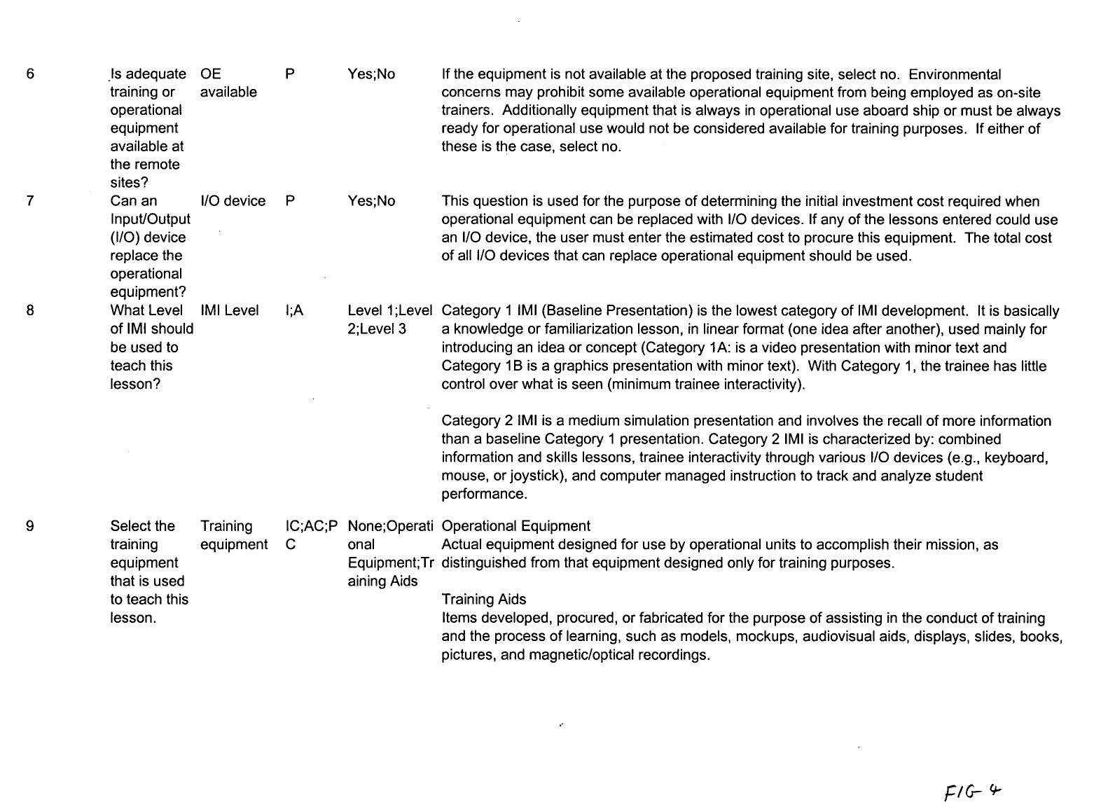

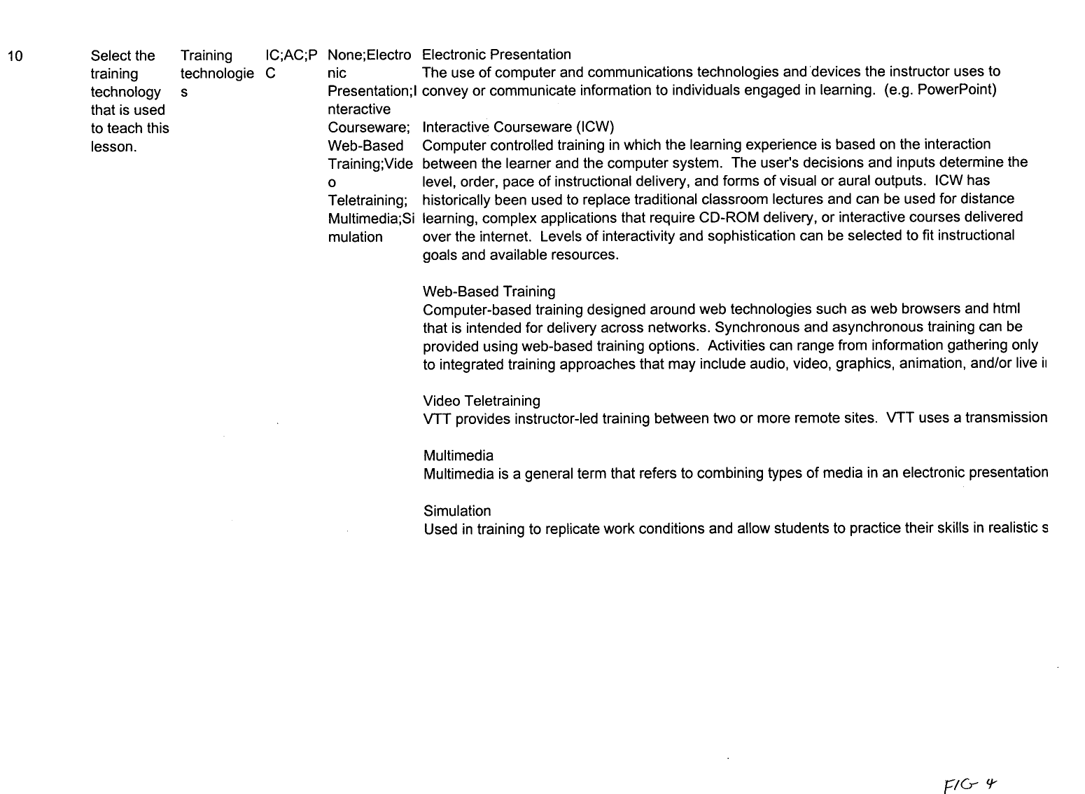

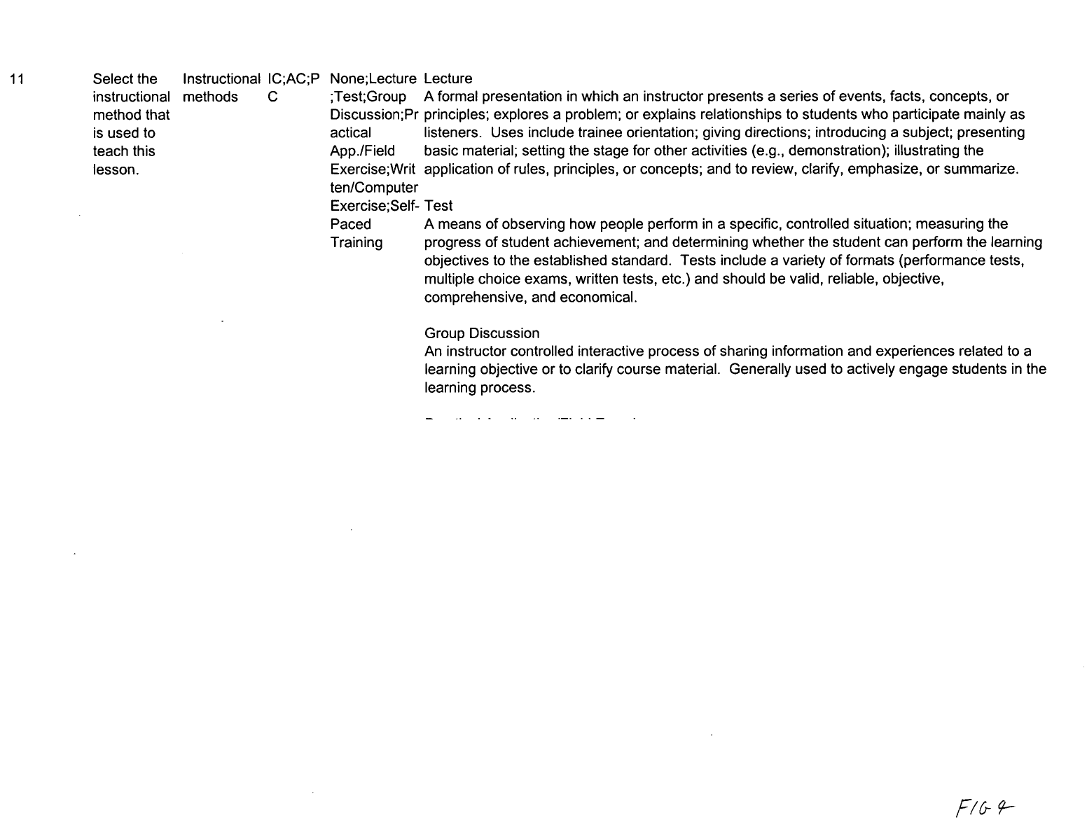

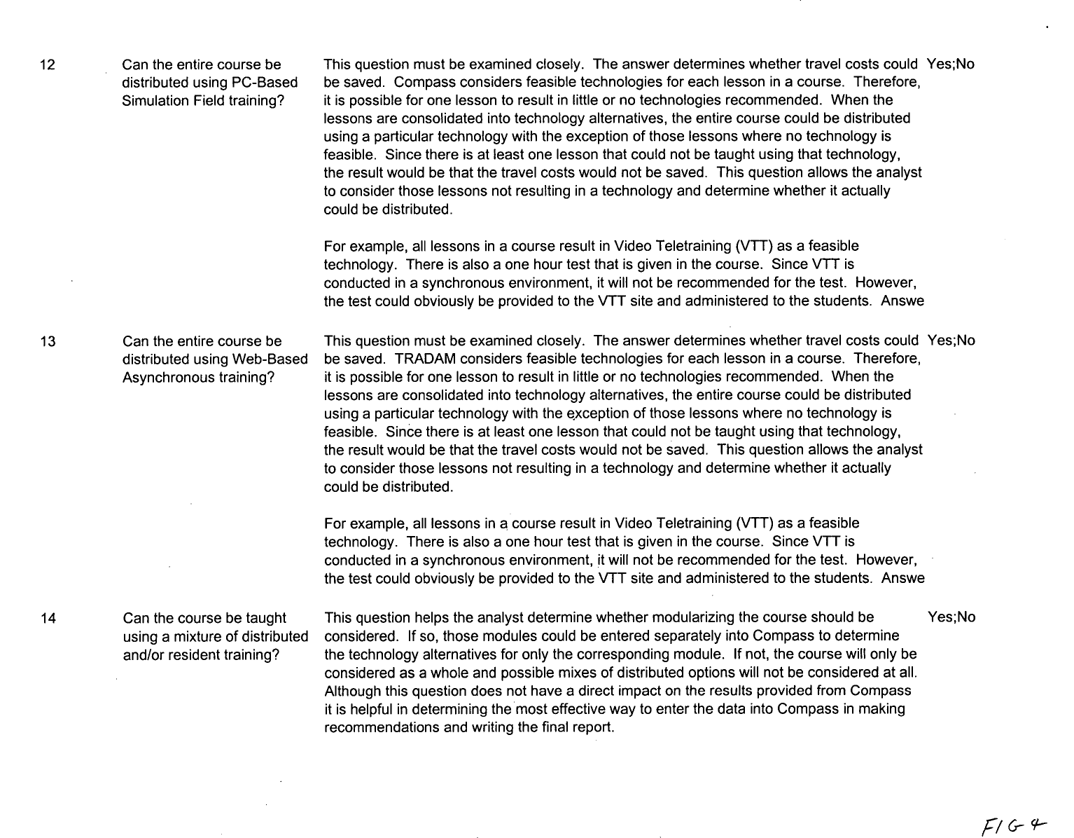

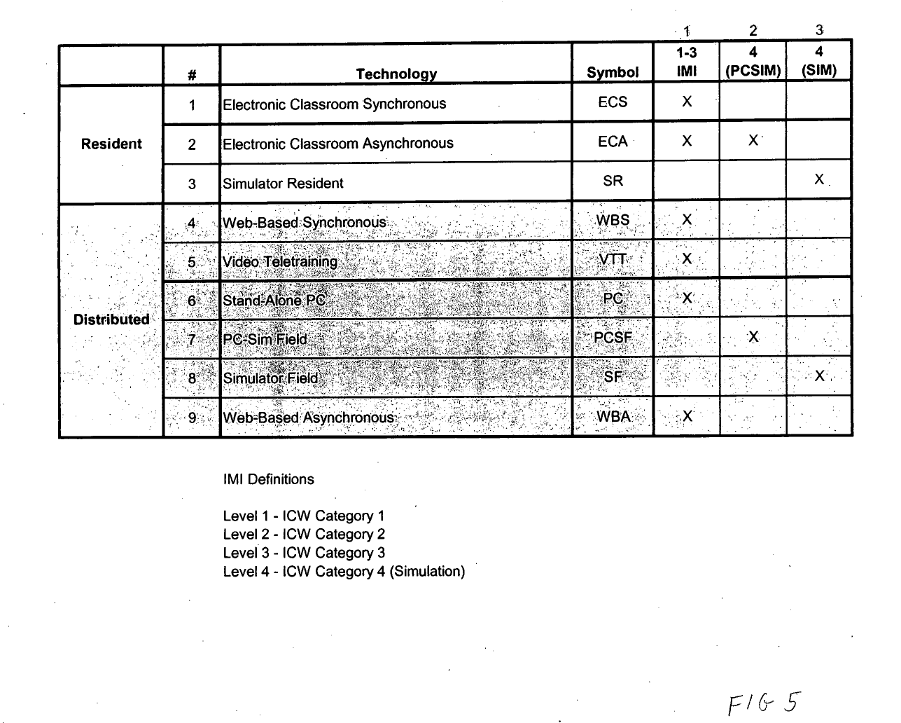

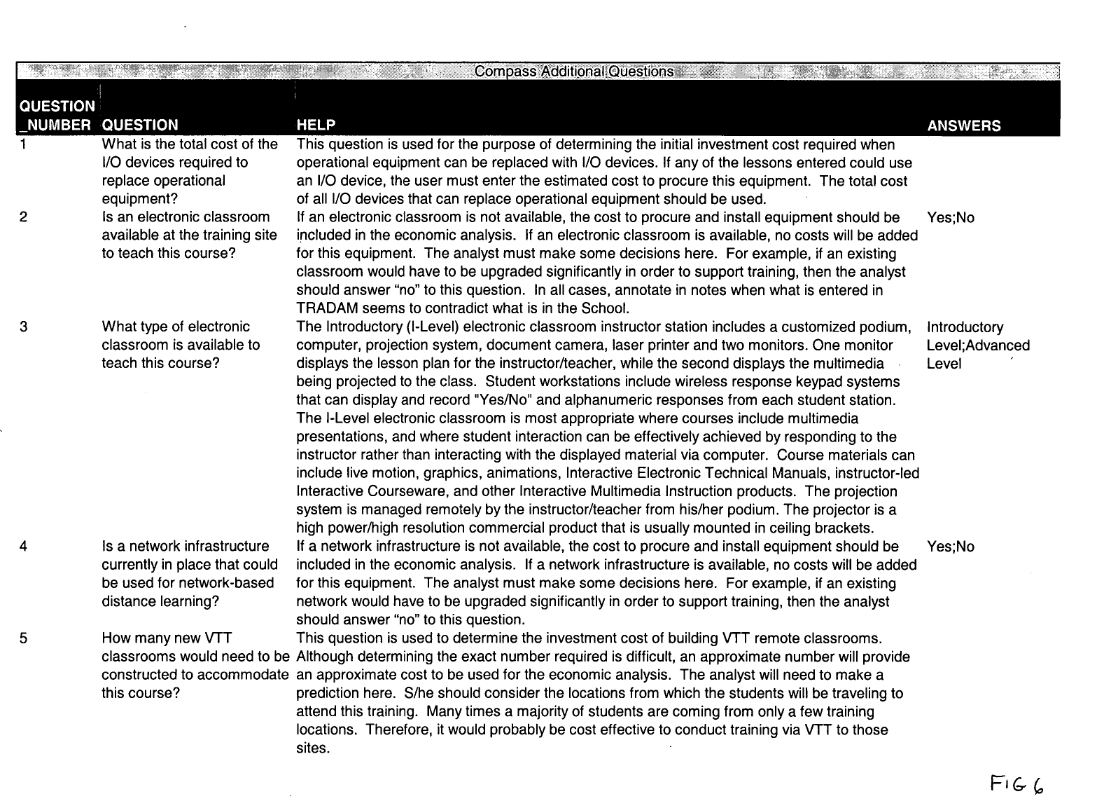

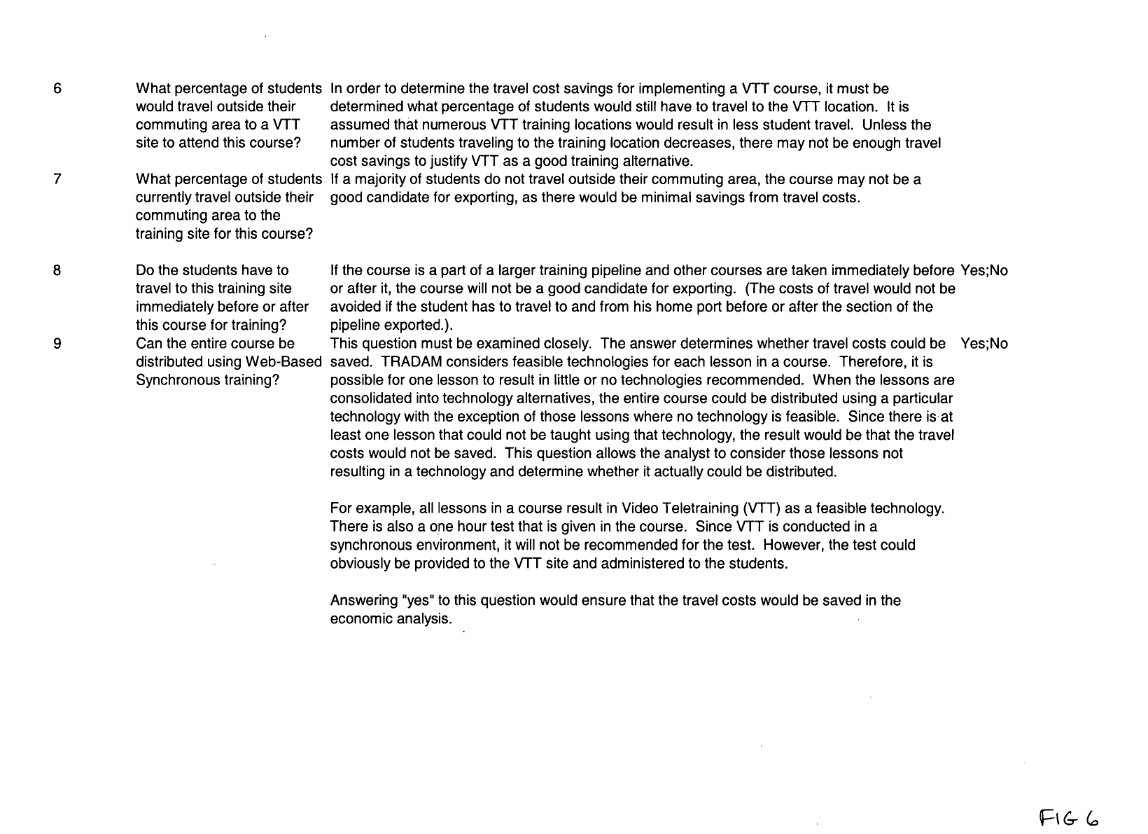

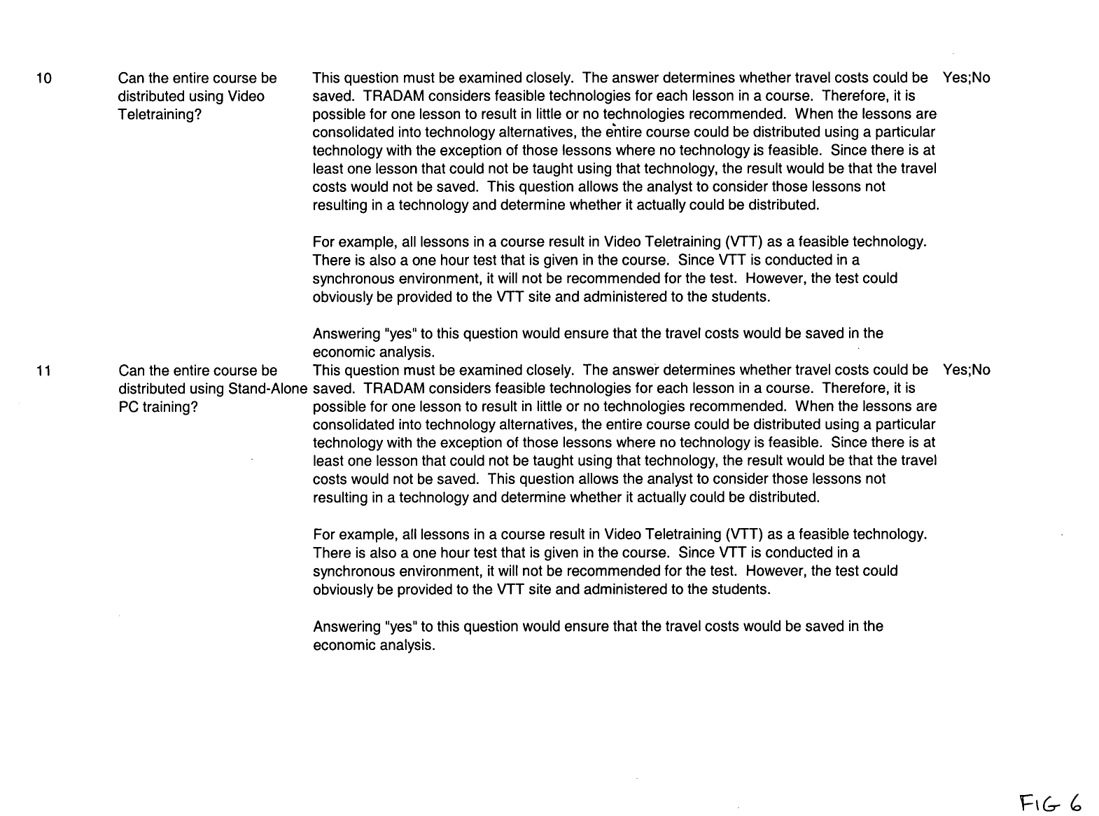

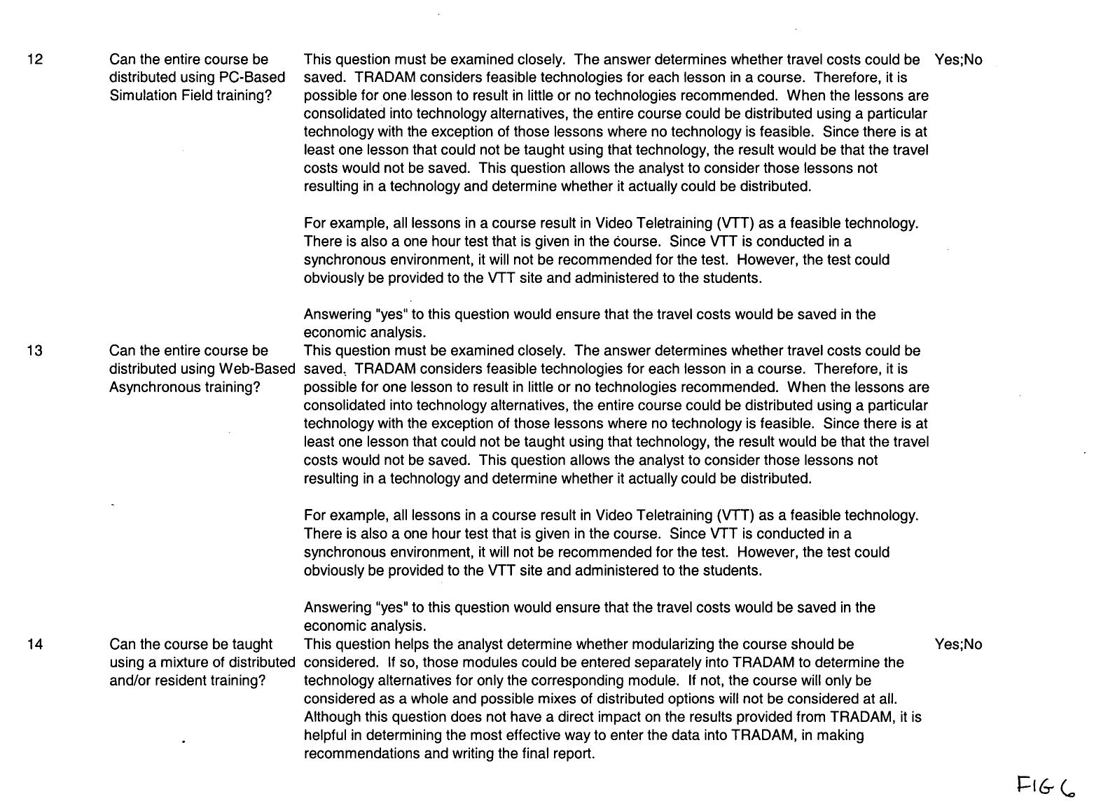

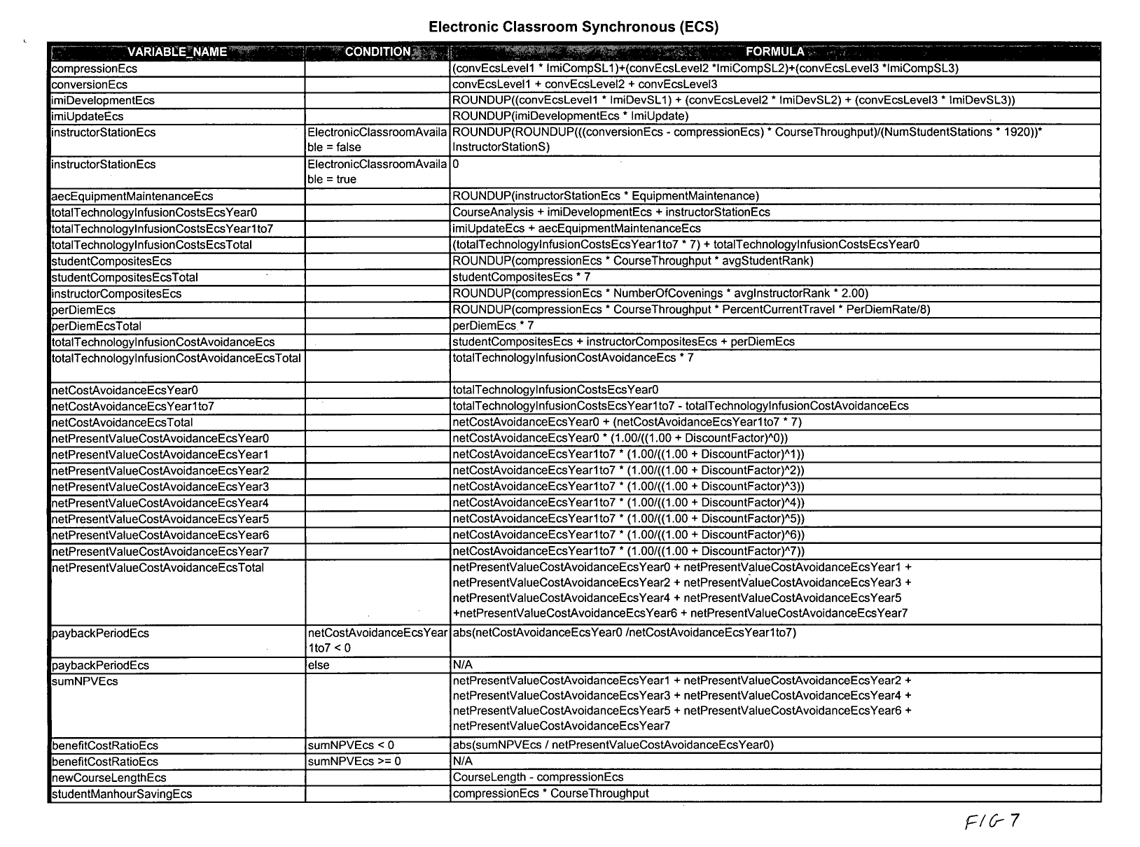

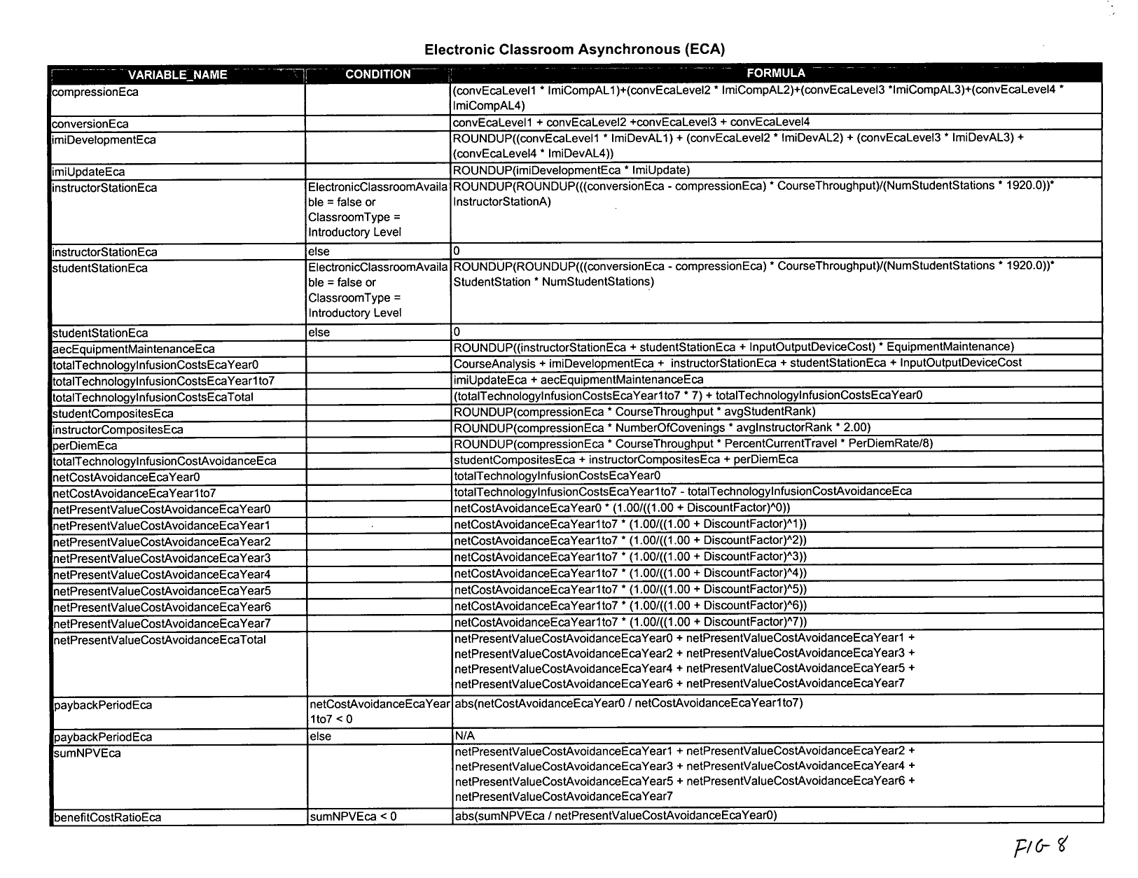

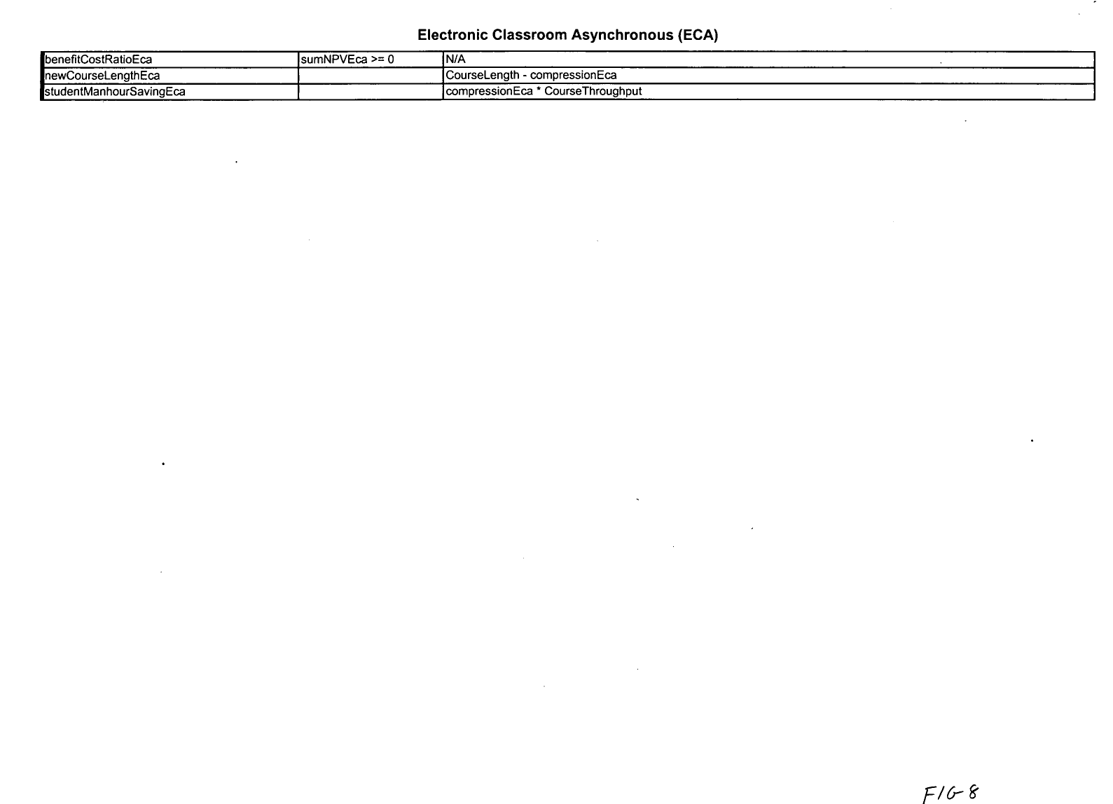

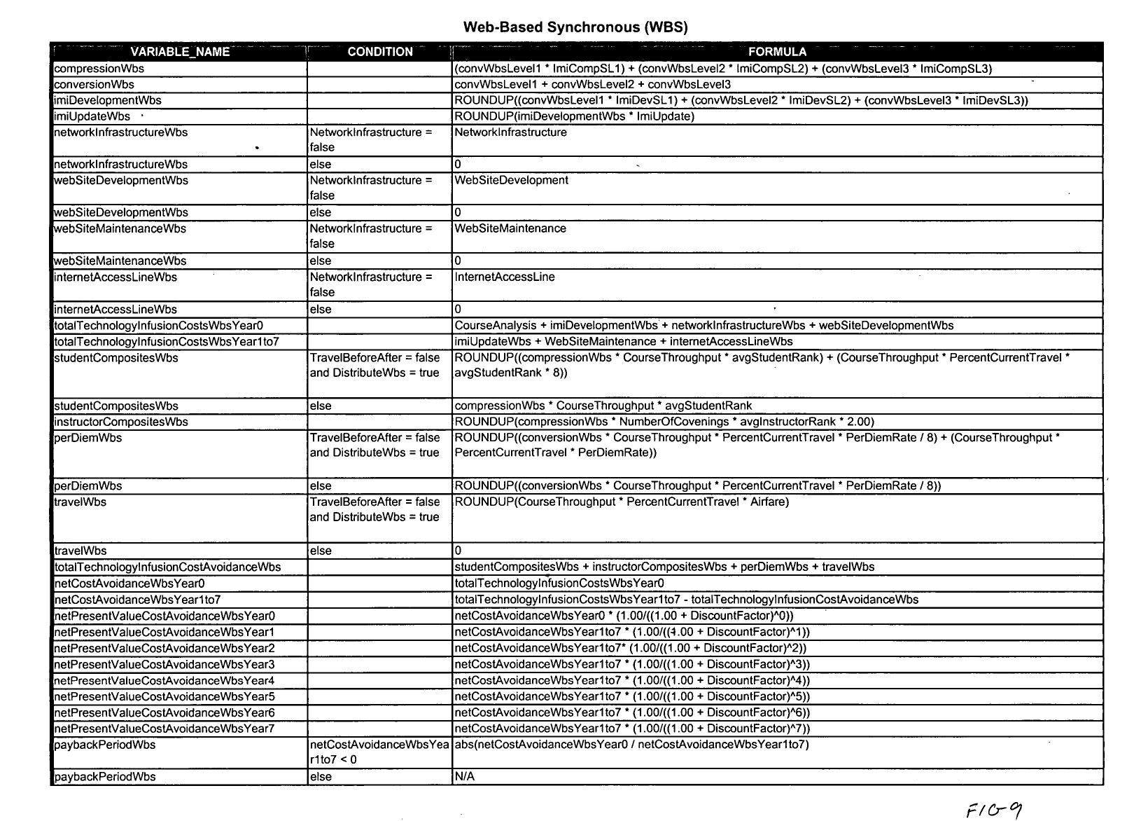

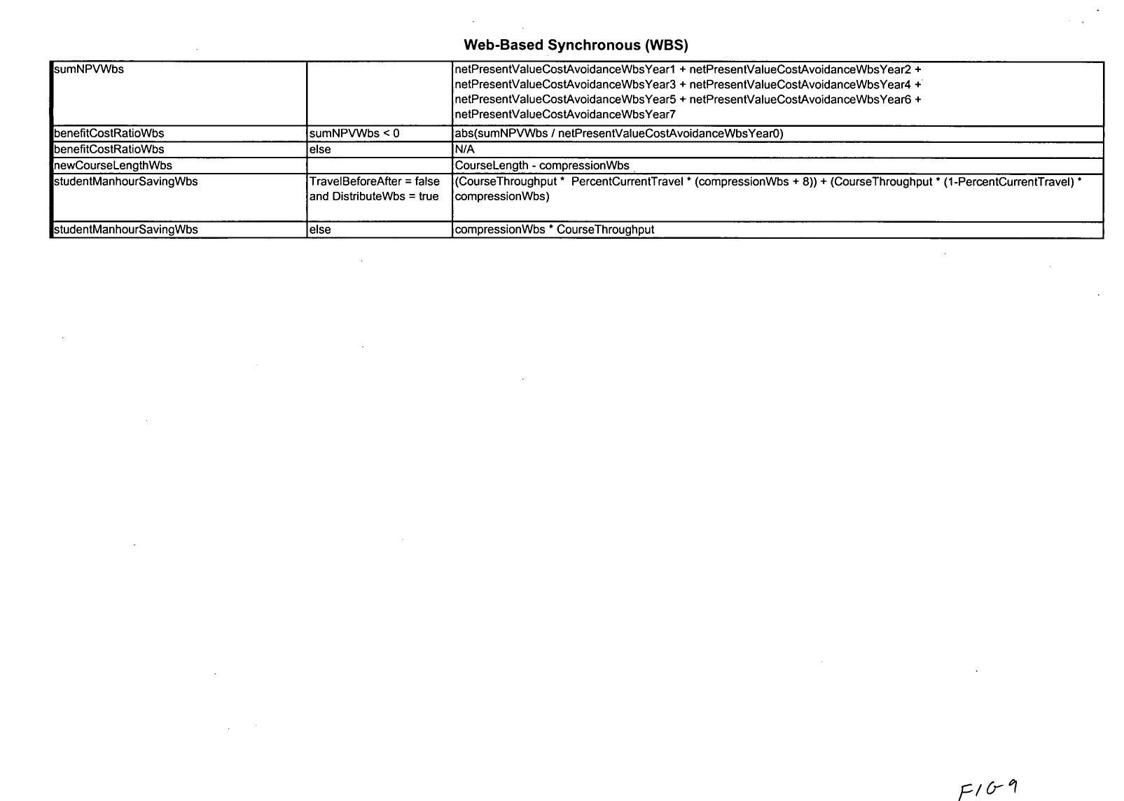

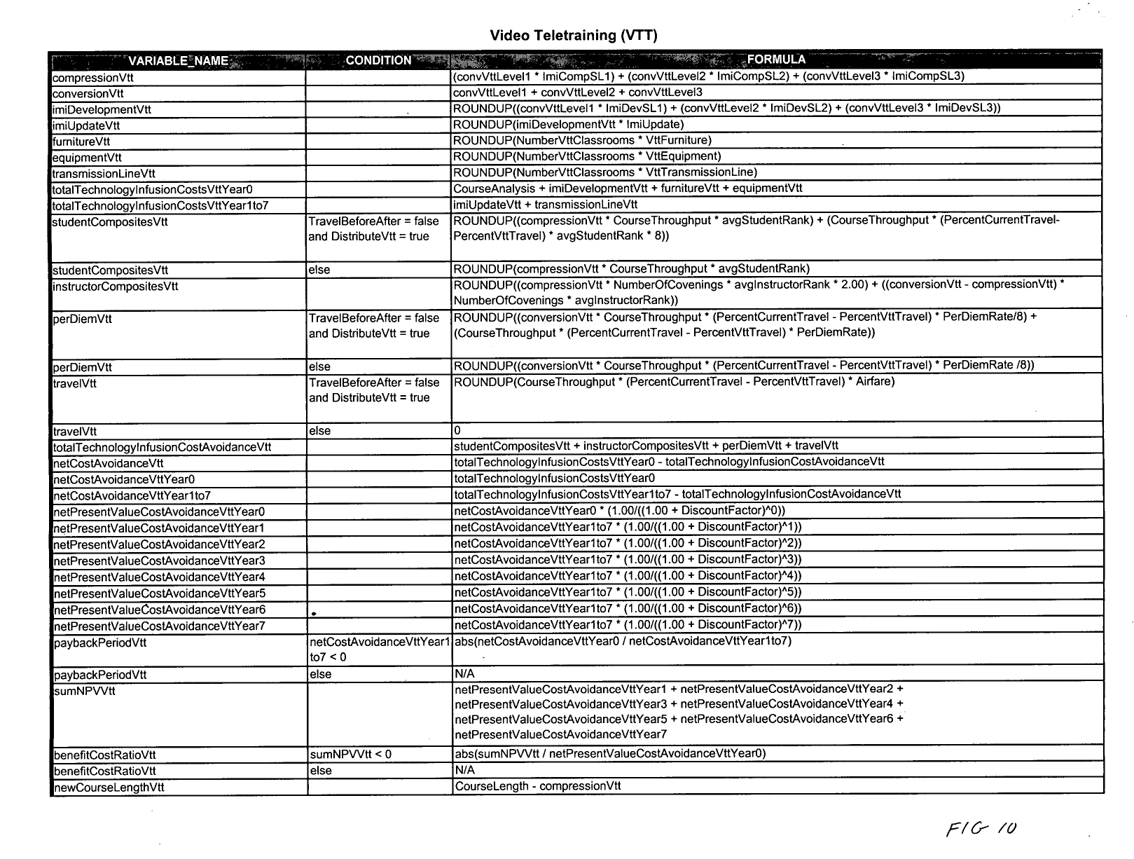

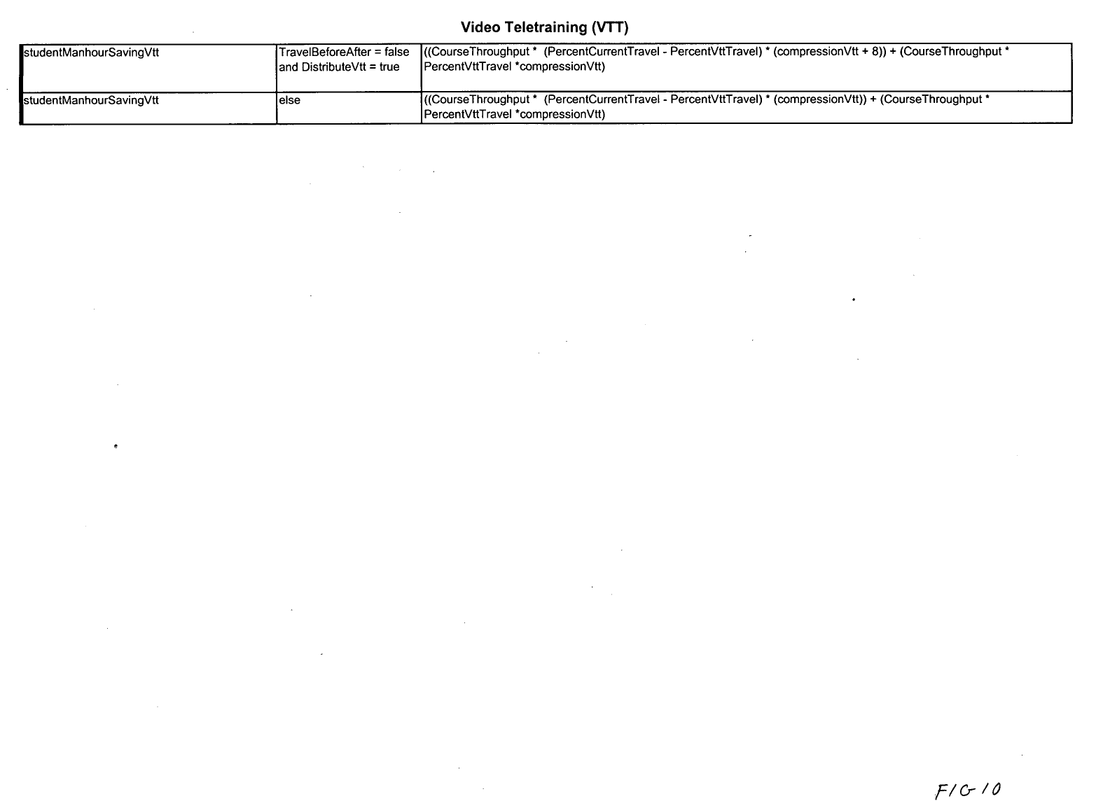

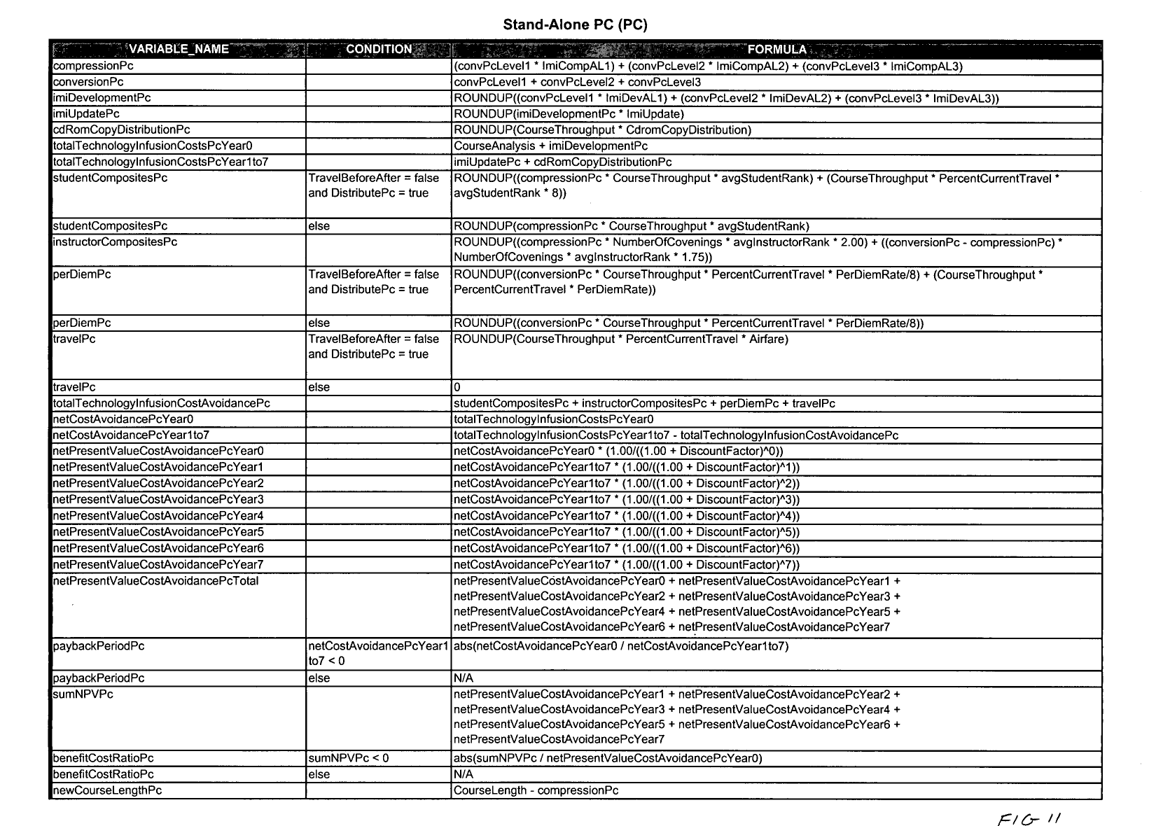

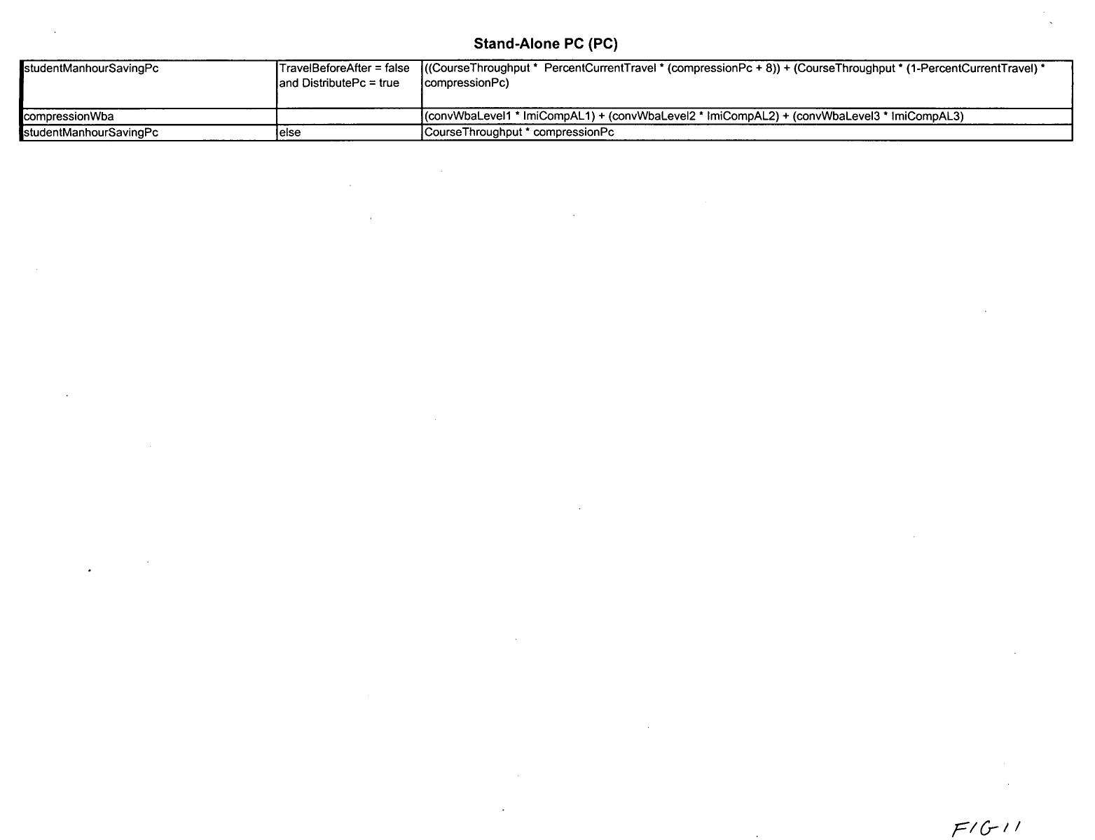

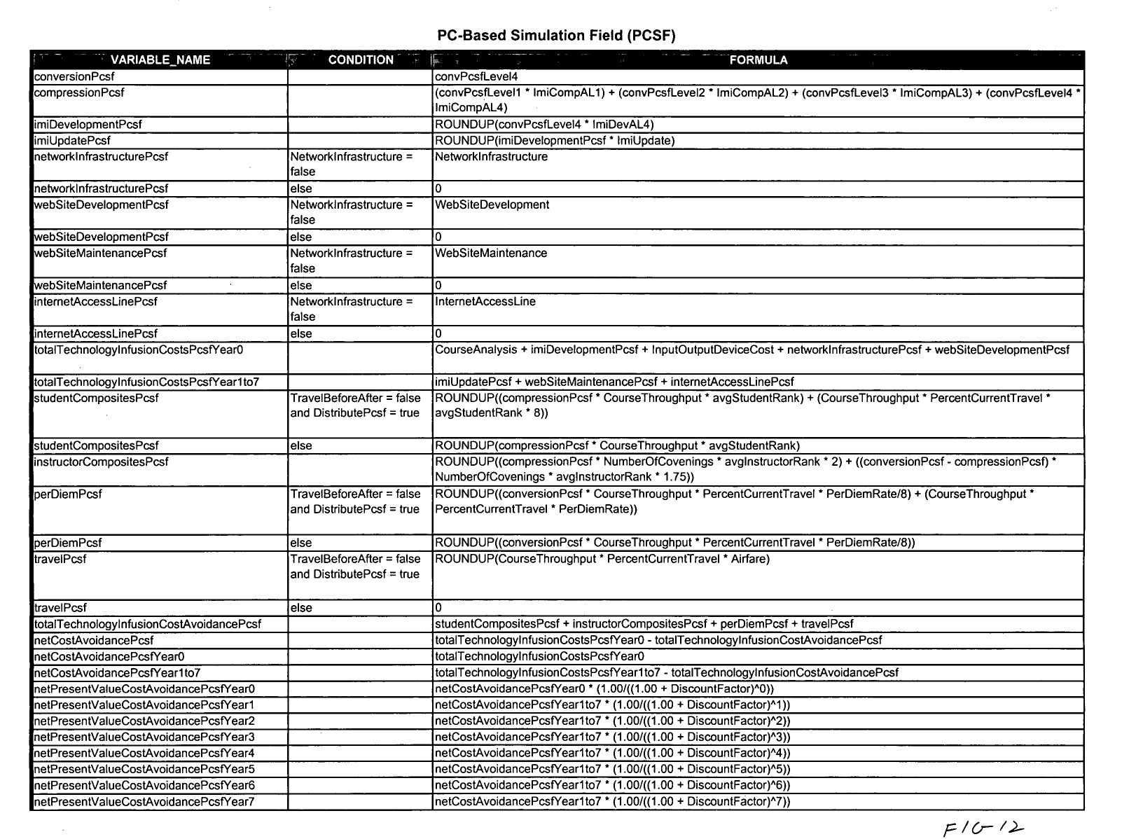

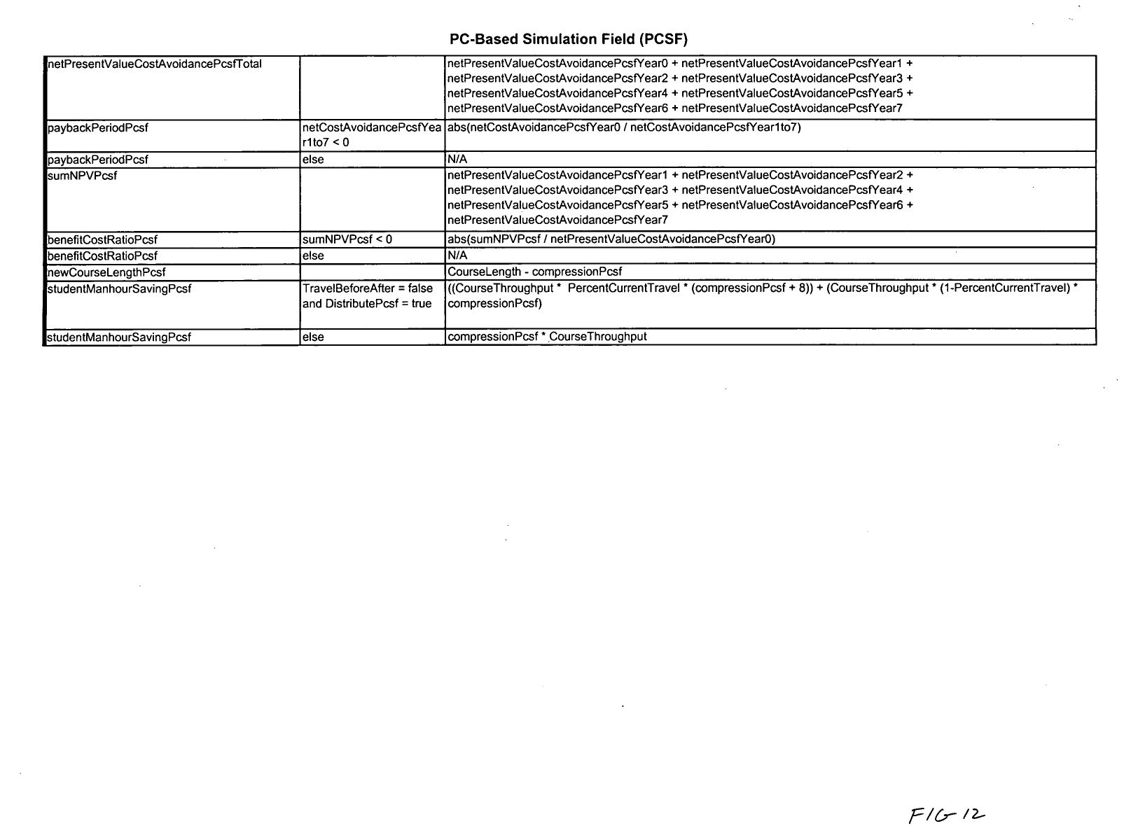

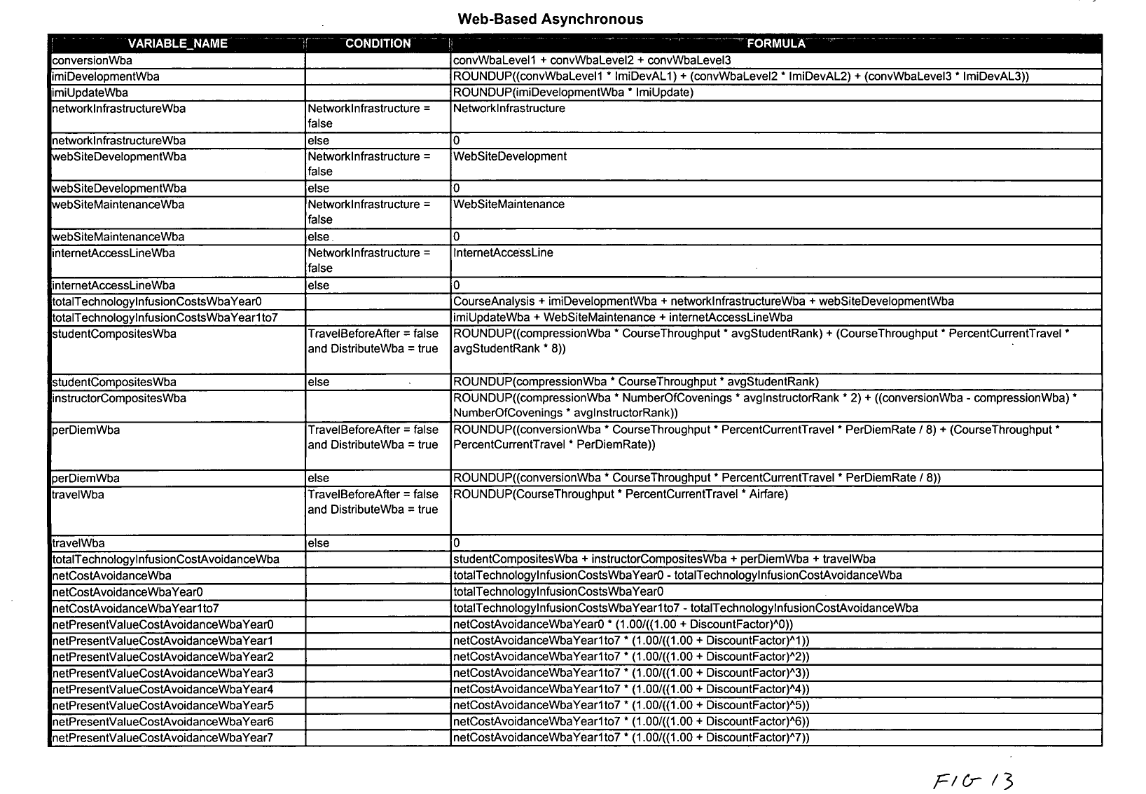

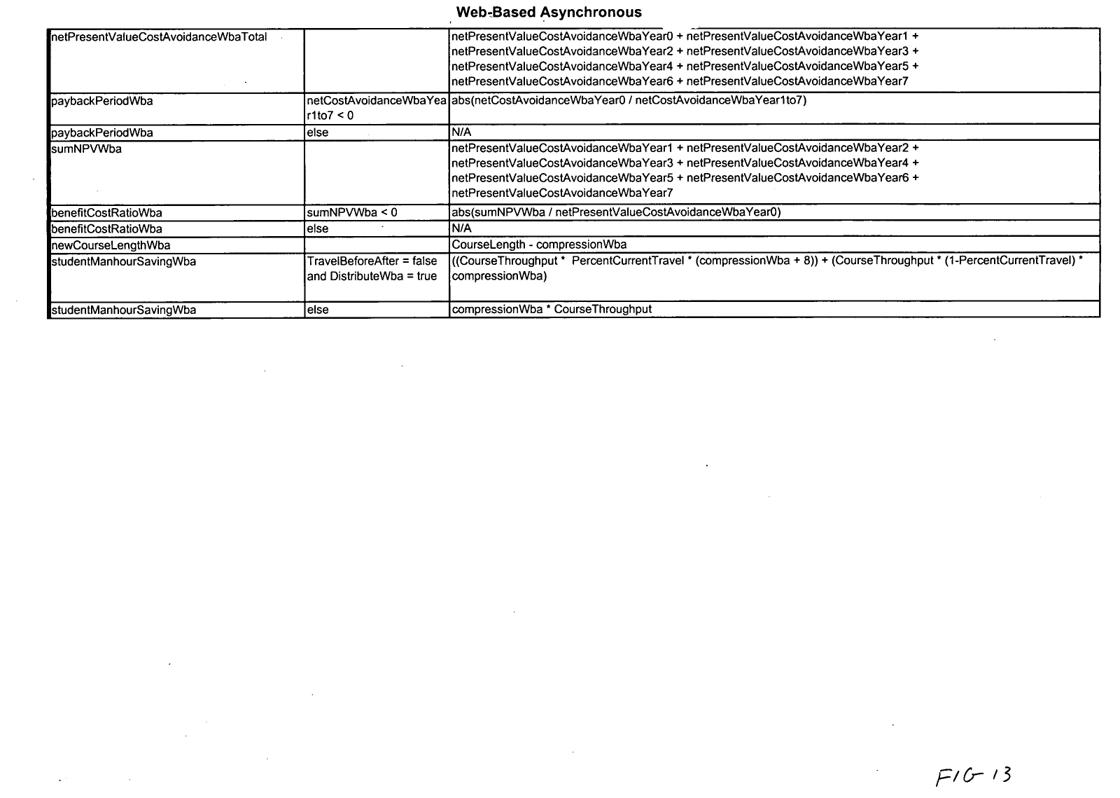

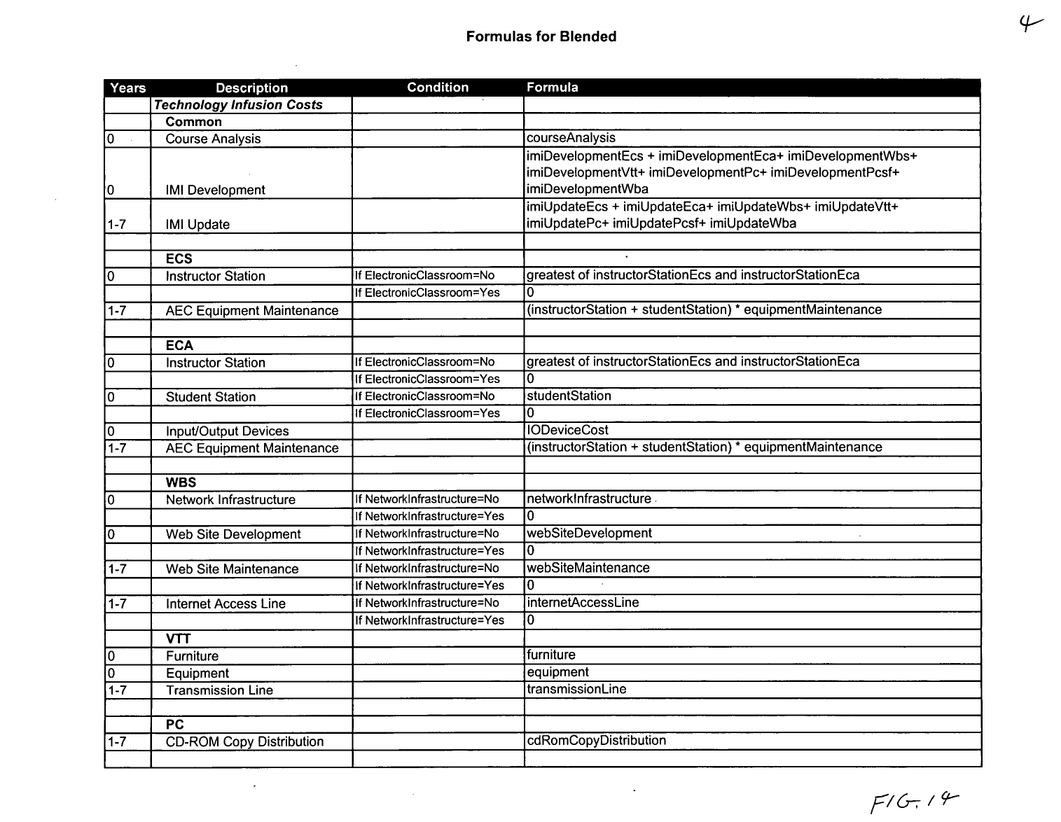

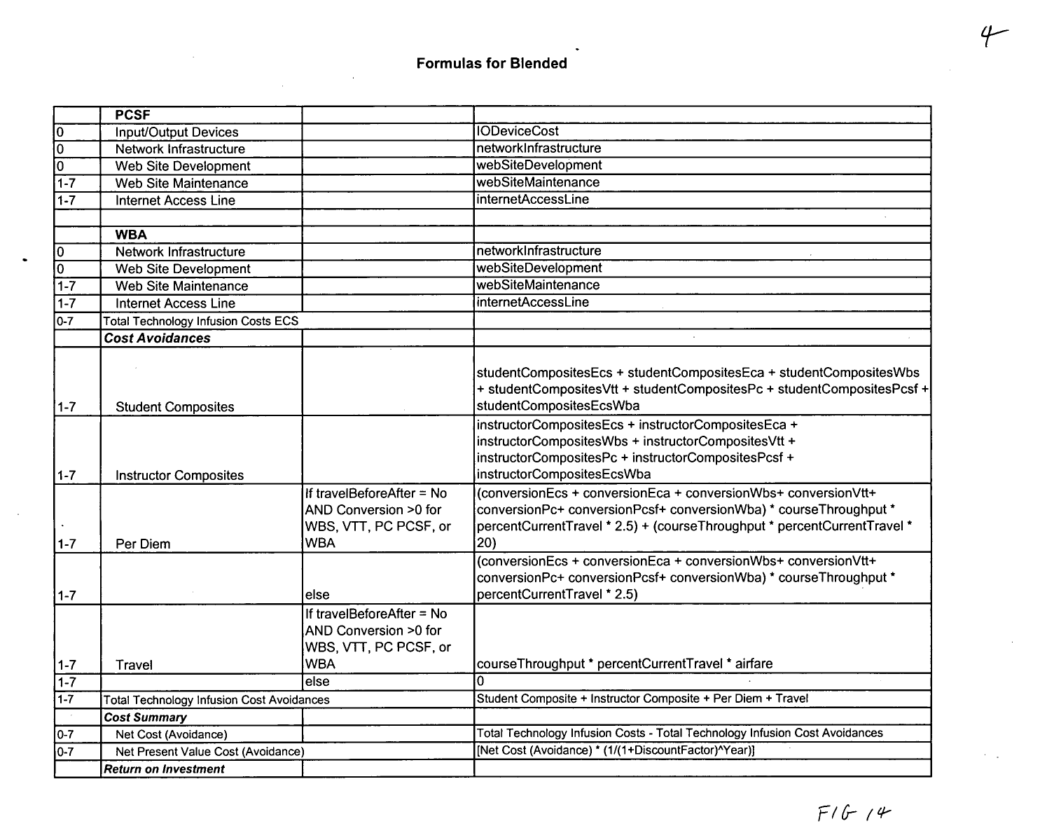

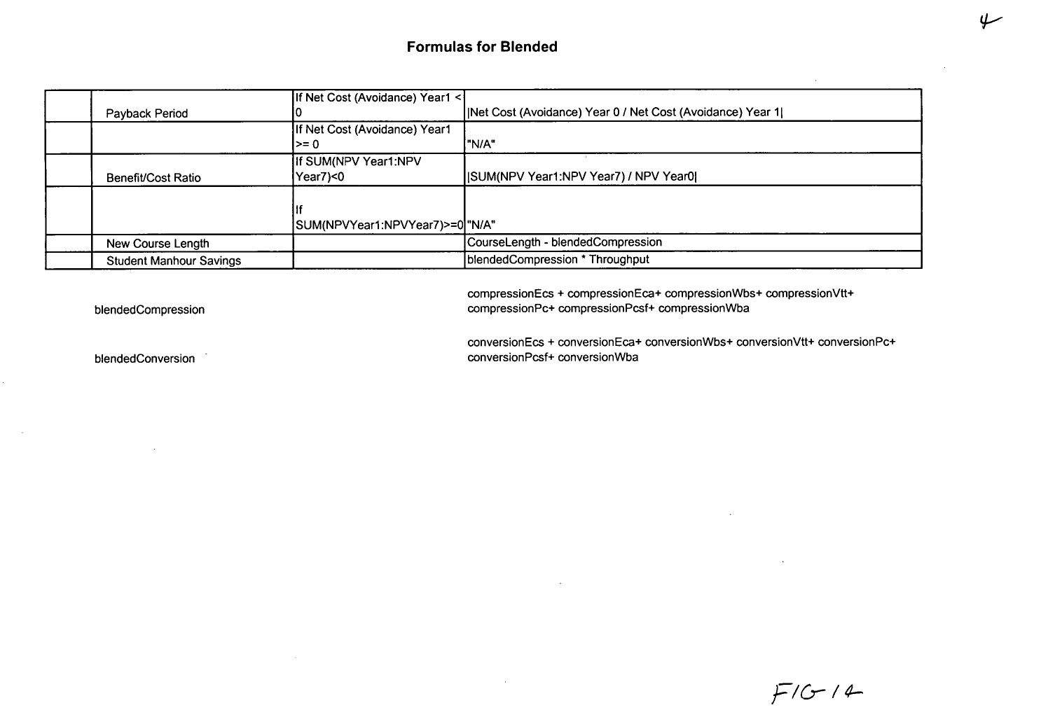

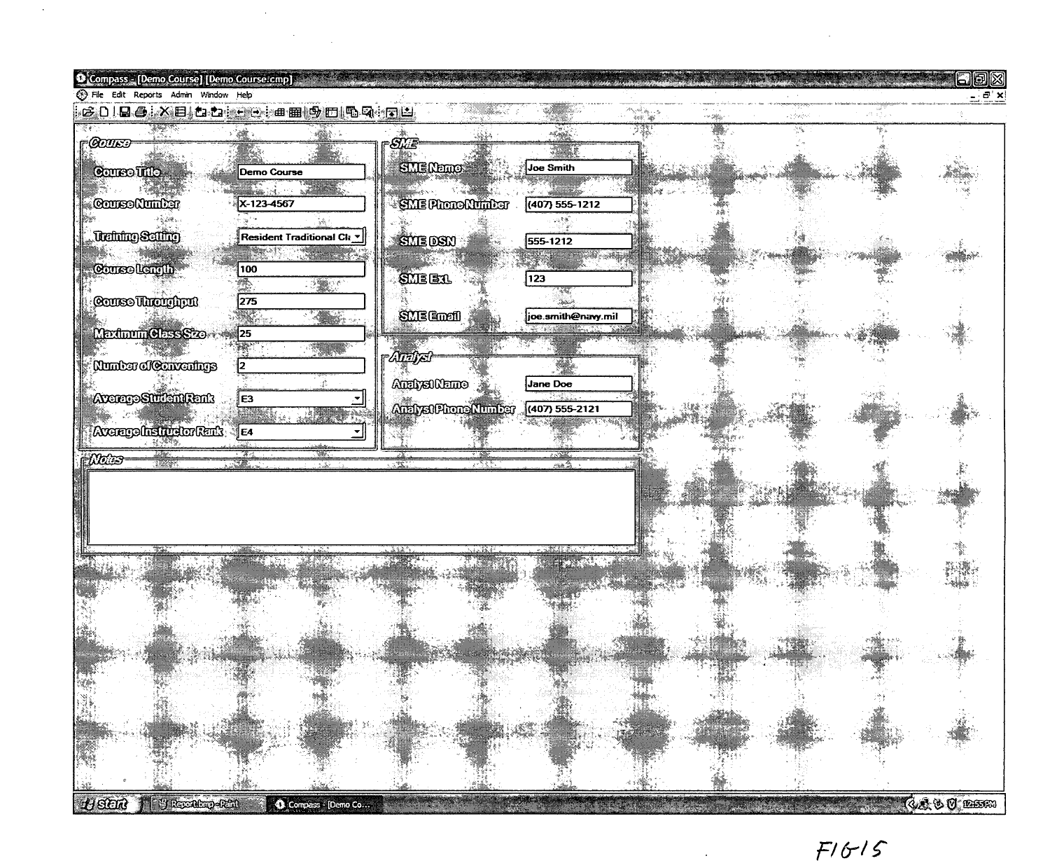

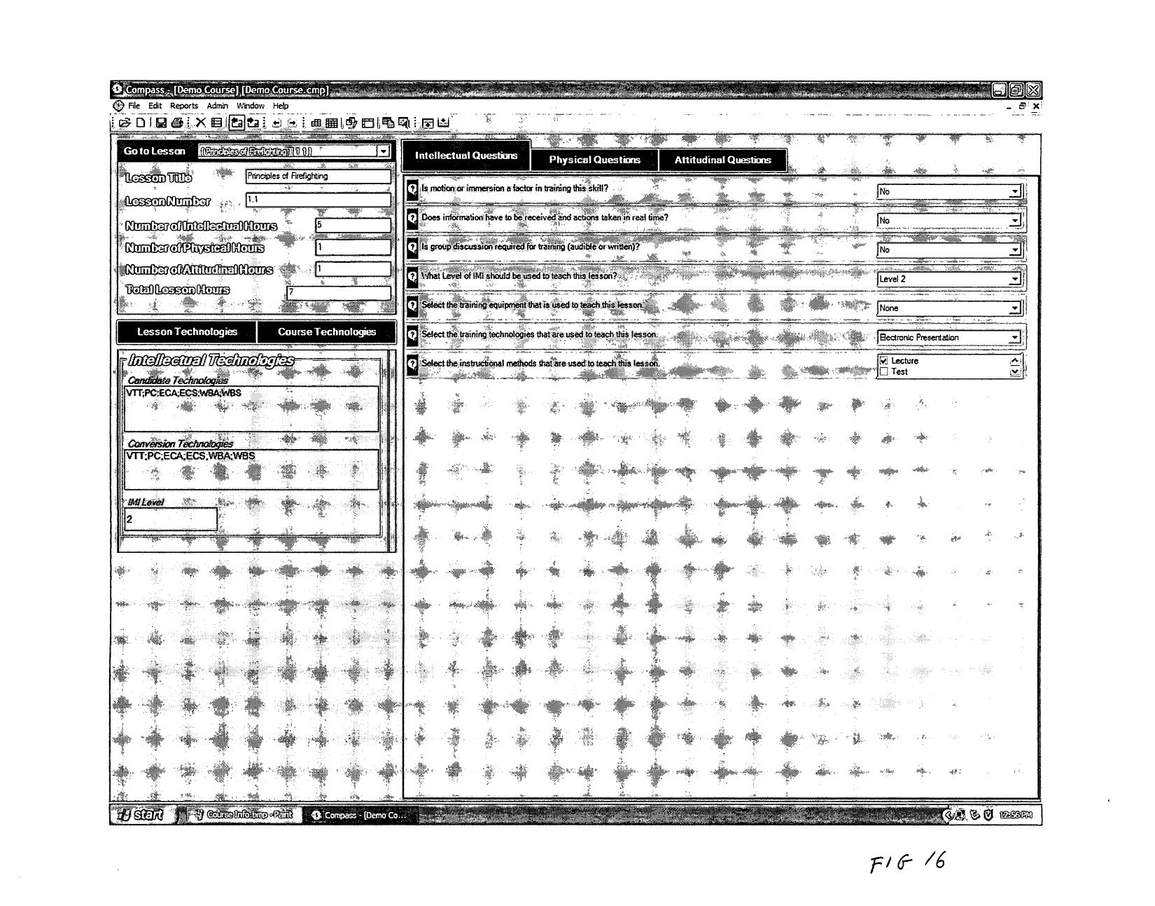

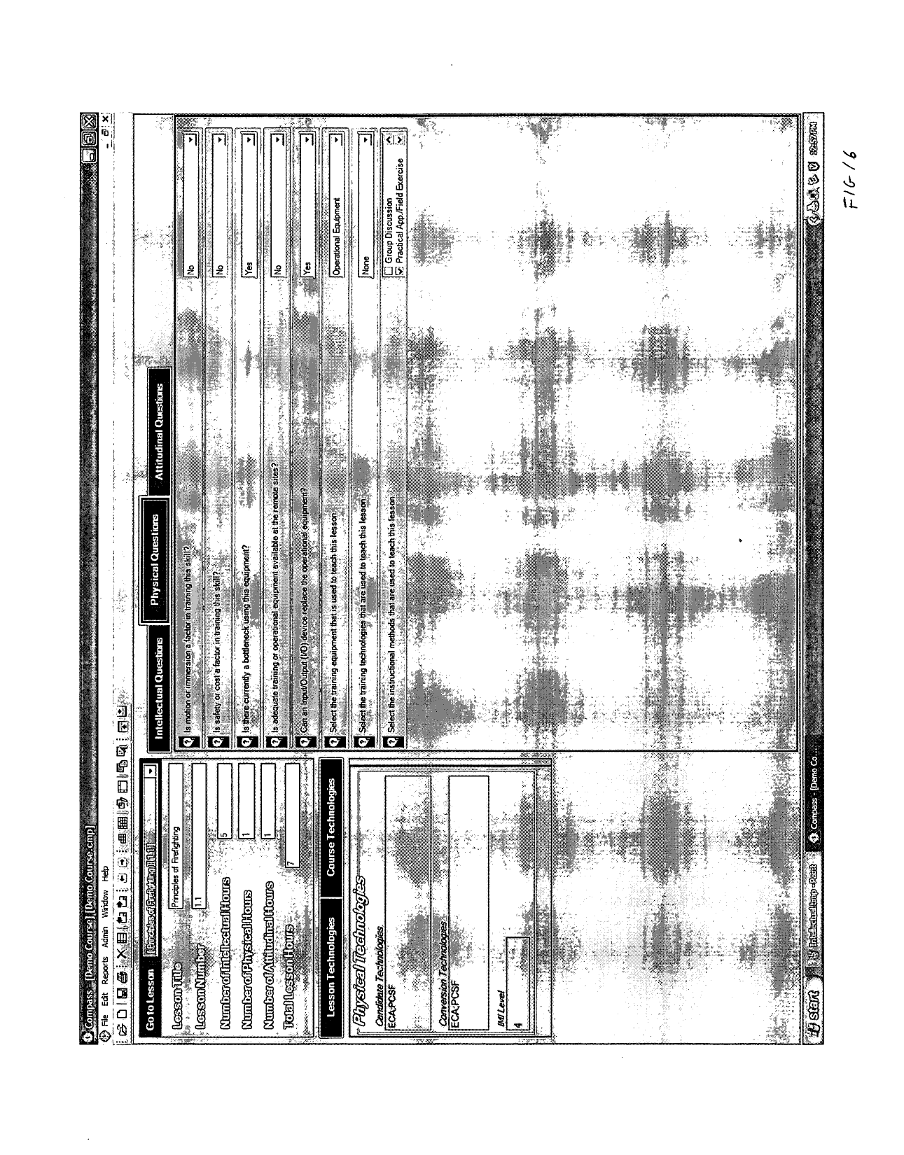

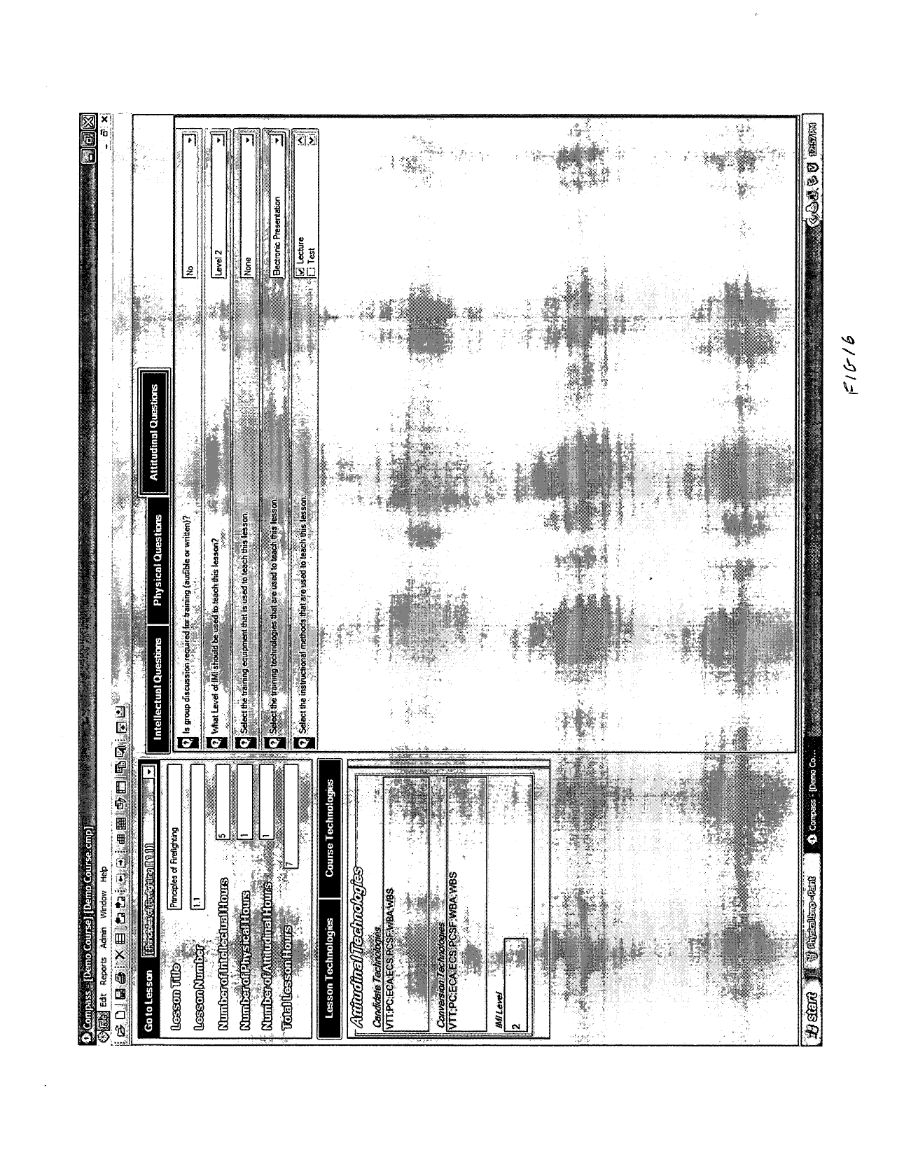

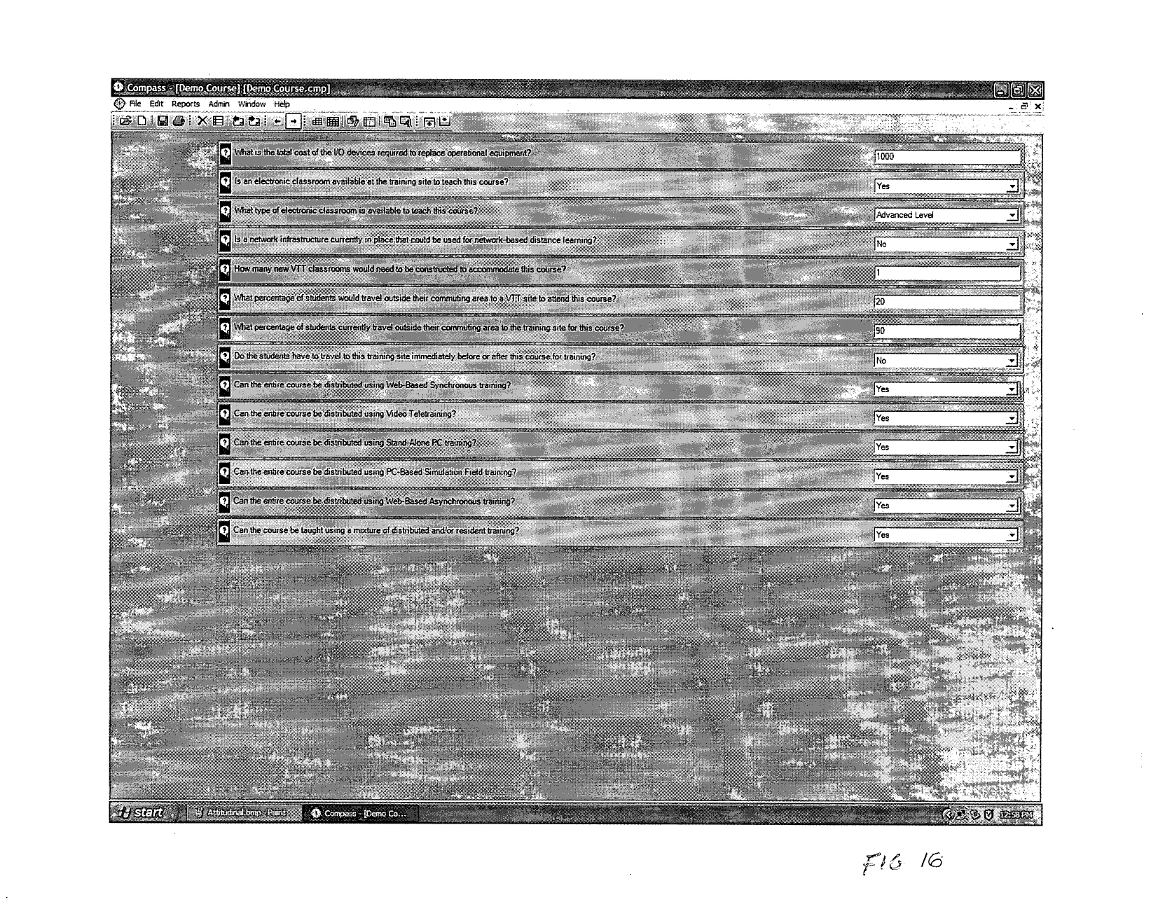

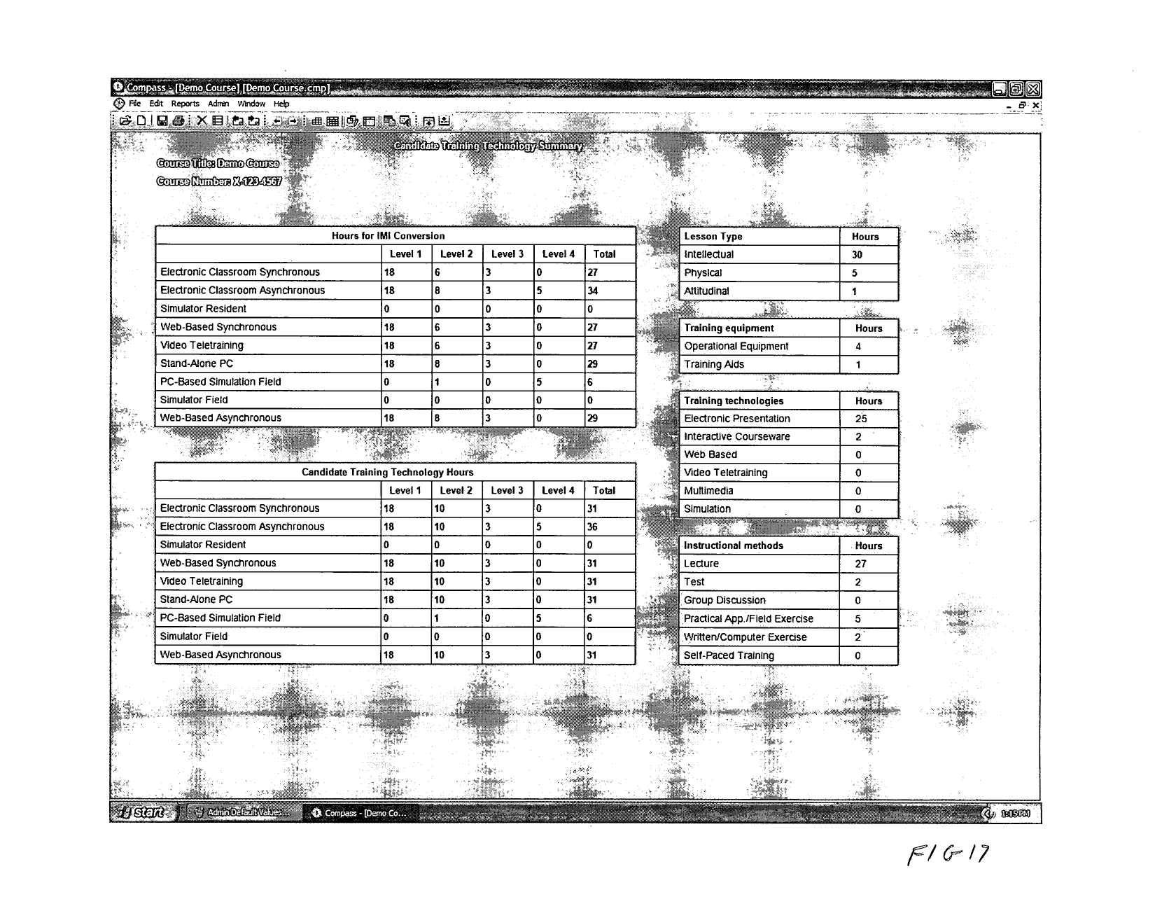

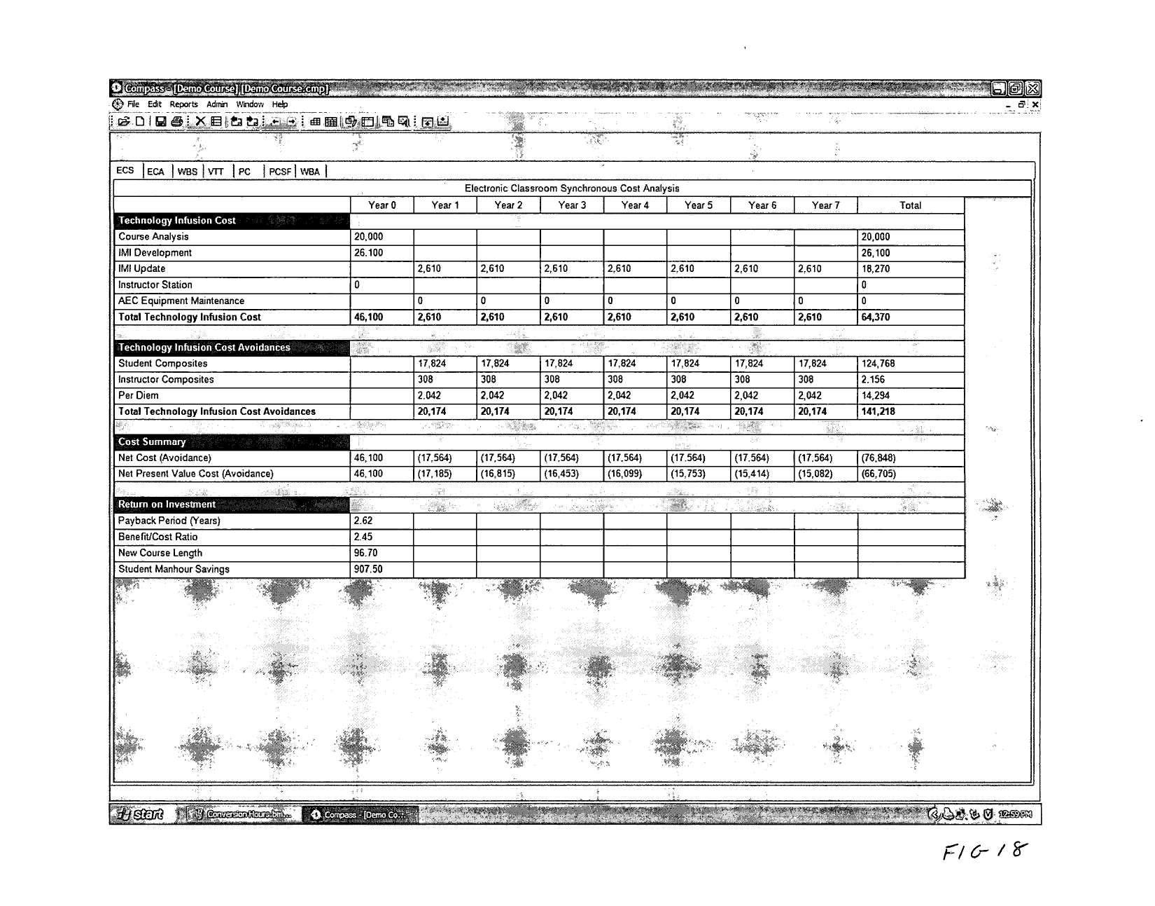

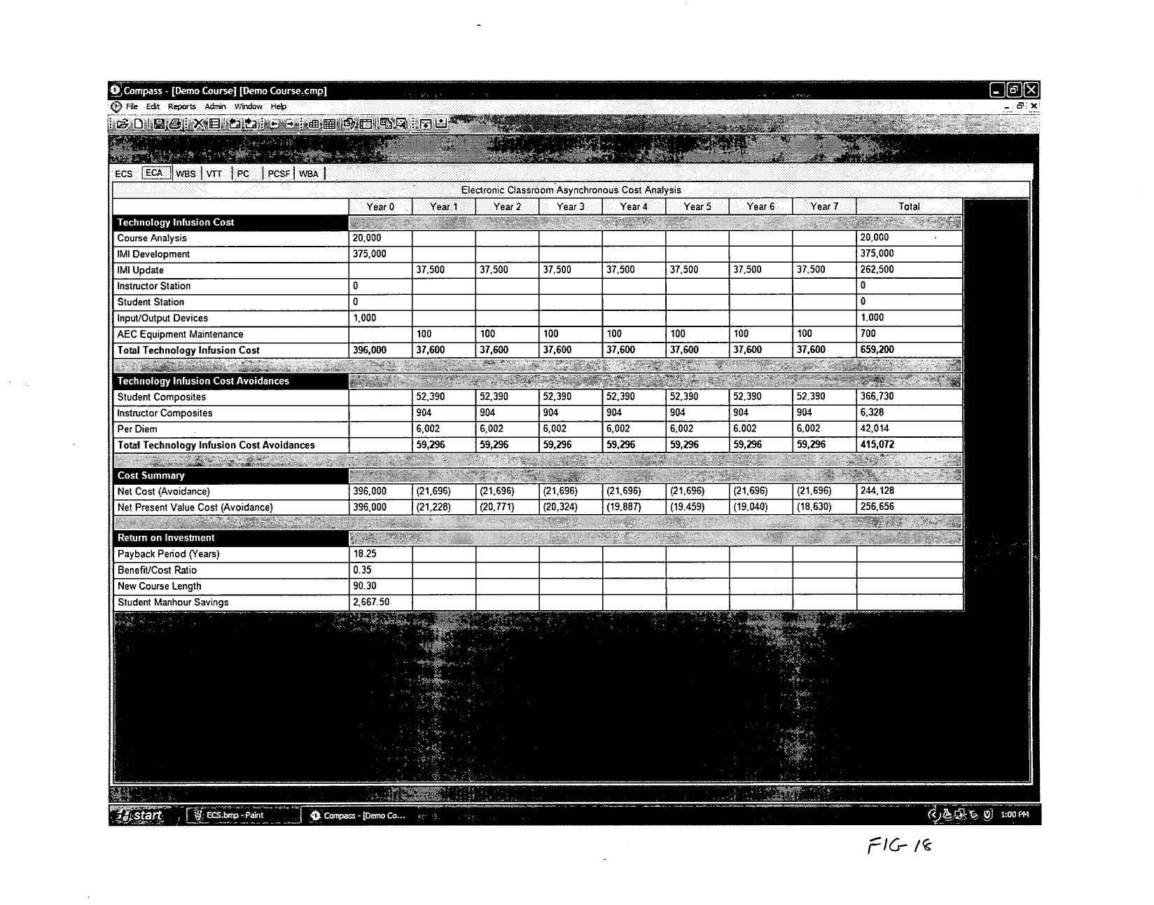

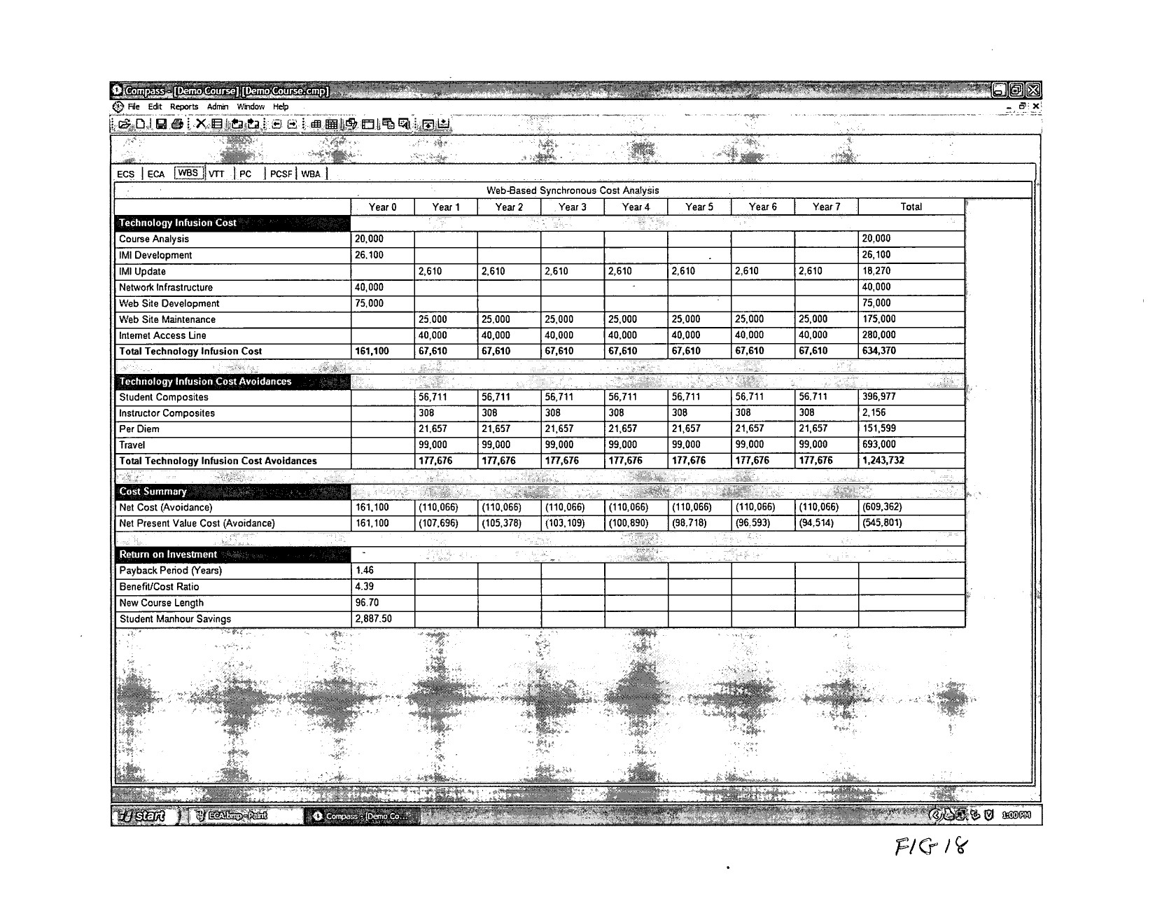

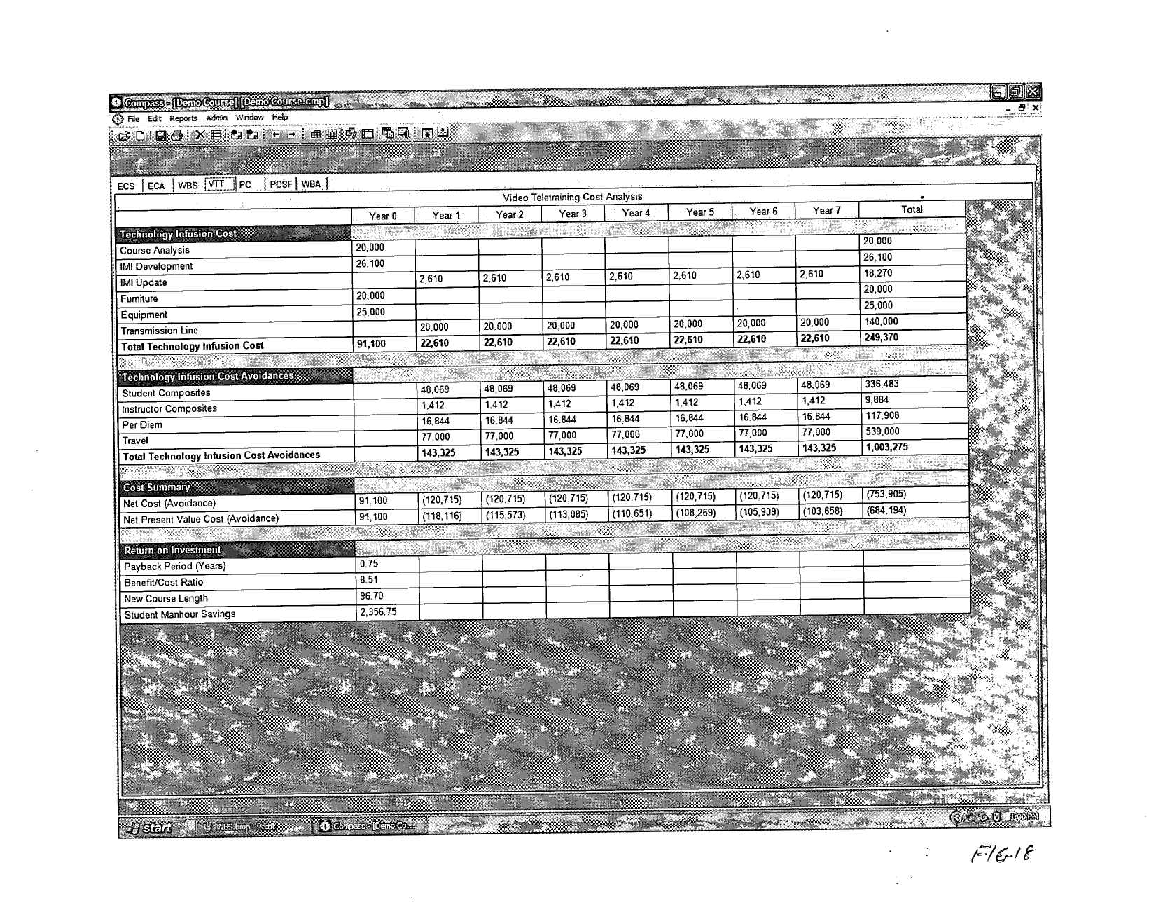

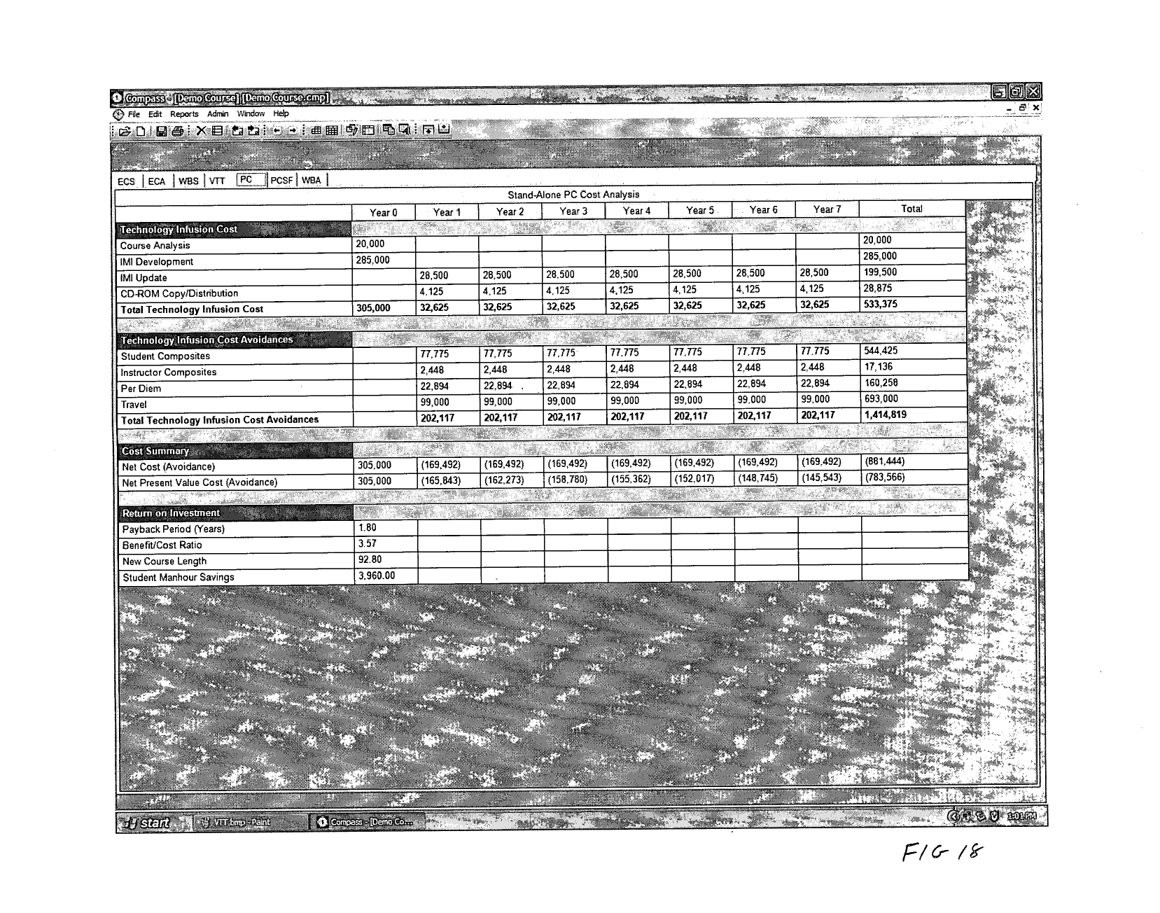

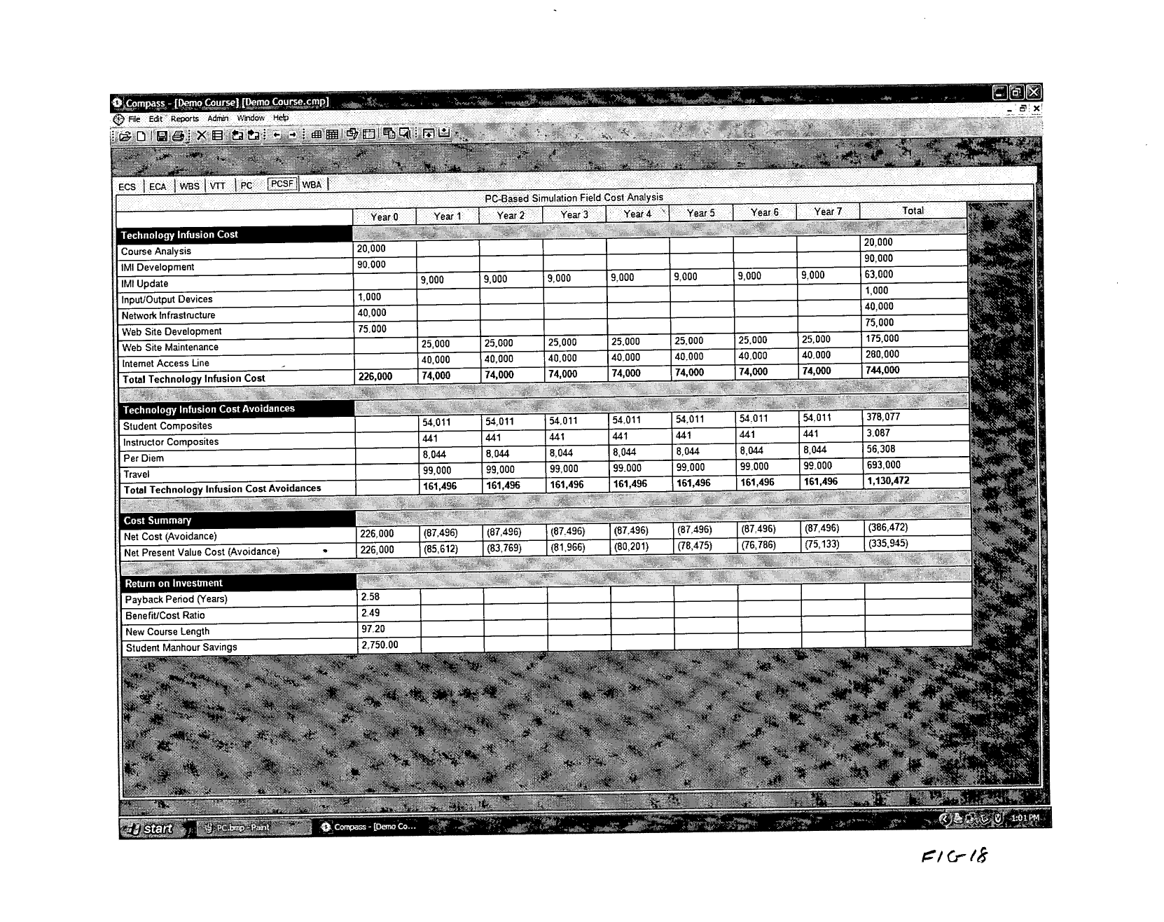

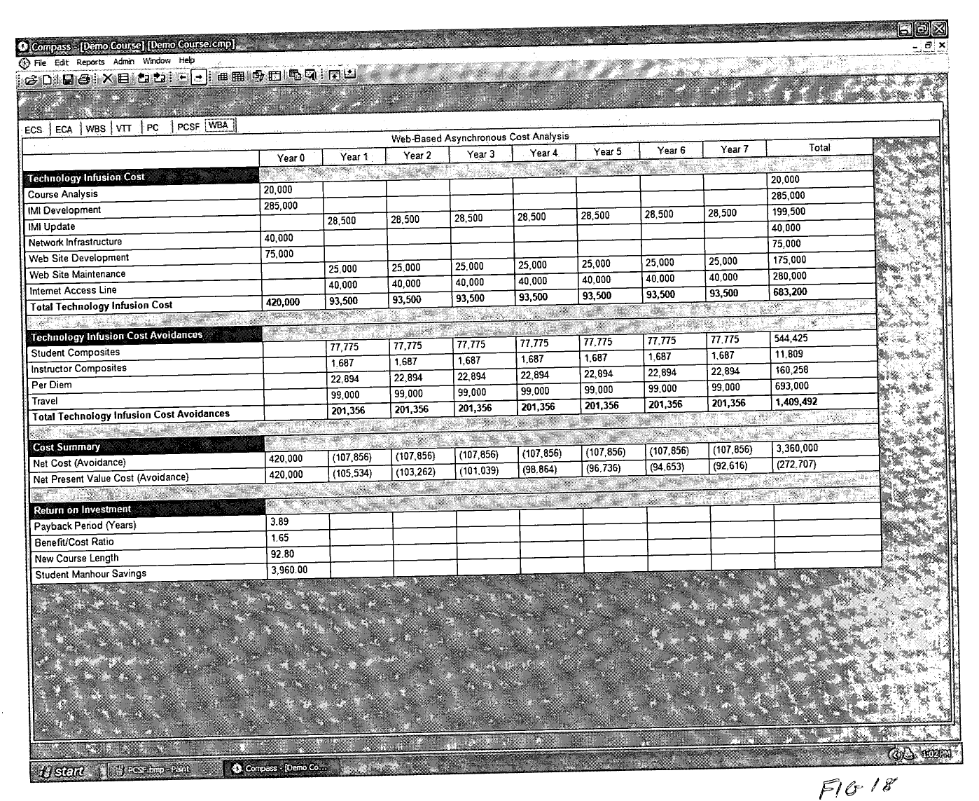

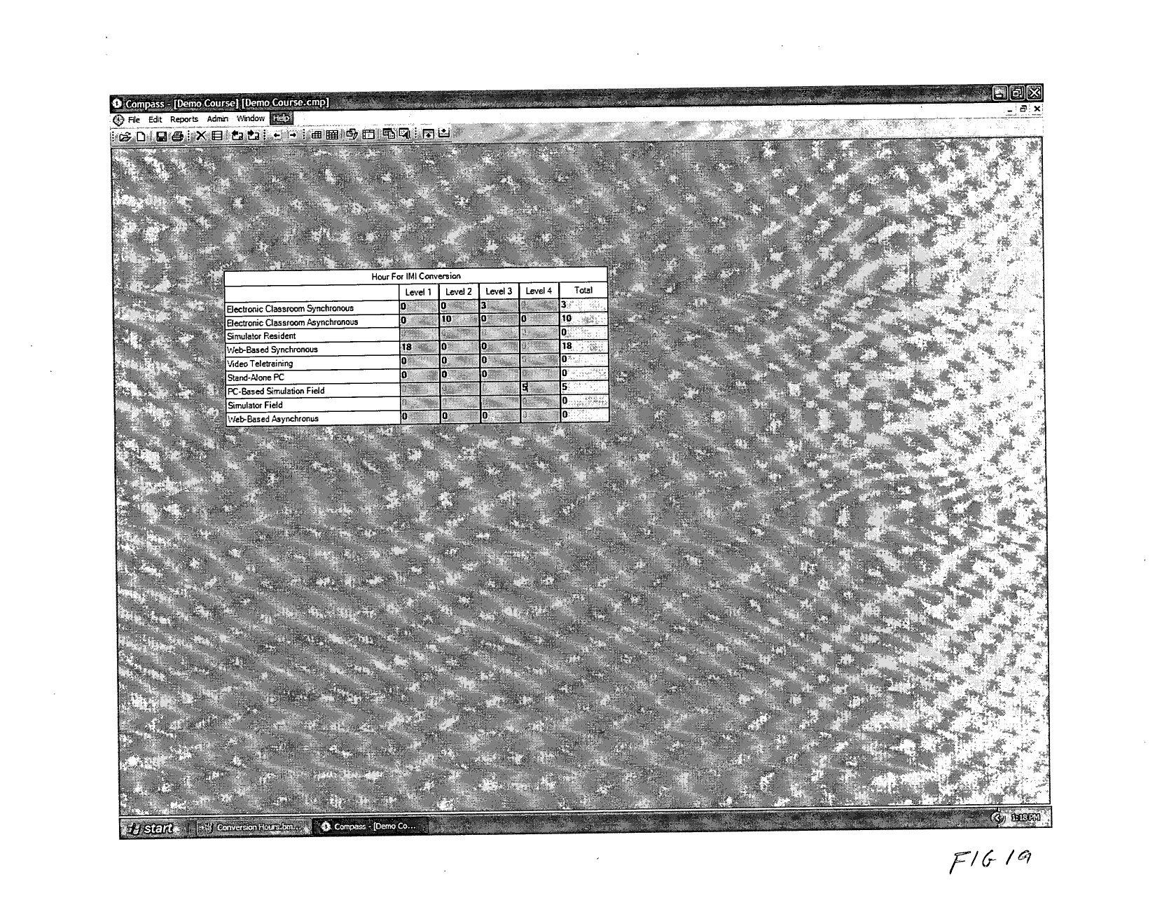

Referring to FIG. 1, an embodiment of a computer for implementing one aspect of the training technology selection tool is shown generally at 10. The computer is a typical commercially available PC capable of running software embodied on the computer media and implementing the training selection tool to be described hereinafter. In the exemplary embodiment the training selection tool includes a personal computer (PC) with a Windows 98™ or higher operating system. PC requirements in the exemplary embodiment are at least 32 MB of RAM and a 120 MHz Pentium processor or equivalent although the training technology selection tool will run on other platforms, which will produce differences in performance. A CDROM drive or equivalent means, for example, an external memory device or Internet download capability is required for software installation. As is well known, the PC contains a memory device such as a hard disk, a microprocessor 12 and input 14 device and output devices 16 and 18. Preferably, the output devices include both a screen 16 and a printer 18. To accept the software and databases, the memory device, for example the hard disk, preferably should have a capacity of at least 10 MB free hard drive space for program operation and data storage. However, the memory requirement may vary and depends upon the expected size of the database. As is well known in the art, memory can be selected to match the database or increased by installing a higher capacity disk drive.

Referring to FIG. 2, the training delivery technology selection process consists of two phases. Phase I is the selection of the training delivery technology alternatives that match the learning requirements of each candidate course. Phase II is the performance of an economic analysis of the selected training delivery technology alternatives.

Phase I Assessment of Technology Alternatives

Referring again to FIG. 2, the phase I analysis is shown at 20. Performance attributes comprising physical skills 22, intellectual skills 24 and attitudinal skills 26 are analyzed through a series of diagnostic questions. The questions supply input to the COMPASS logic 28. The logic functions in real time to analyze the input in order to provide a series of candidate technologies able to implement the performance attributes.

Referring to FIGS. 3A, 3B, 3C and 4, the logic for the present embodiment is illustrated for the three performance attributes. Each question is answered either “yes” or “no” to provide a digital on-off input into the logic. For each performance attribute, up to seven questions are provided for determining which of nine outcome technologies are within the range of choices. Questions may appear in more than one attribute logic and may be answered differently from the identical question residing in the other logic.

Referring again to FIG. 4, fourteen questions are shown. Only the first seven questions are used to determine the candidate technologies. Questions 8 through fourteen are also answered during the phase one analysis but are not processed by the phase I logic. Question 8 is provided for the phase II cost factor determination. Questions 9 through 11 are provided to filters that provide cost information for converting the present training program to the outcome technologies recommended by the phase I logic. Questions 12 through 14 are provided for informational purposes.

For each course that is analyzed as a candidate for the application of technology, COMPASS identifies all appropriate training delivery technologies that will satisfy the training requirement(s) while also contributing to training efficiency. The tool thereby performs a detailed assessment of training delivery technology feasibility for each of the lessons taught in the course. The process accesses various databases to collect information about the current training, determines the type of learning involved, and identifies requirements for the student interface with the instruction and training content.

Different types of learning require different types of instructional interactions, strategies, and activities. Each lesson or unit of a candidate course must be examined to determine the types of learning that are required by the lesson objectives. Three general domains of learning are analyzed in the Training Technology Selection Tool logic: intellectual skills, physical skills and, attitudinal skills.

Intellectual skills comprise fundamental concepts and terminology, basic operator and maintainer procedures and principles, troubleshooting strategies and similar intellectual abilities. Content areas sometimes called knowledge (factual knowledge, process or procedural knowledge, conceptual knowledge and schema), or cognitive content. As is well known in the art this includes Gagne and Briggs intellectual skills, cognitive strategies, and verbal information. If the lesson is currently taught in a classroom, the lesson probably contains intellectual skills learning. For example, intellectual skill objectives are found in training associated with the content areas of electrical and electronics theory, basic seamanship, preventive maintenance procedures, and weapons systems operator procedures.

Physical skills are learned capabilities, for example psychomotor skills or motor skills. The learning and performance of physical skills involve the senses and the brain as well as the muscles. Training physical skills involve repeated practice (with frequent feedback on performance) that improves accuracy, speed and smoothness of motion. There is no easy way of avoiding practice if one seeks to improve the performance of physical skills. Some examples of tasks requiring physical skills training are: piloting an aircraft, driving a vehicle, operating a fire hose during firefighting, engaging in damage control operations, and swimming. One lesson can contain training on both physical and intellectual skills. Those lessons that do not involve extensive physical practice do not contain physical skills training.

Attitudinal skills are a system of beliefs and include perspectives on the world that affects an individual's choice of action toward some object, person, or event. Training in the content areas of leadership, equal opportunity, continuous quality improvement, and prevention of sexual harassment includes some attitude objectives along with intellectual skill objectives. Training in these content areas is intended to accomplish more than the understanding of concepts, rules, and principles. The training is intended to influence the attitudes, and thus the behavior of the training participants.

The identification of appropriate training delivery technologies for these classes of learned capabilities depends on several factors. These factors include the student interface with the learning content (amount and nature of stimuli and feedback), the amount and nature of interactivity between students, and the visual representations, for example, 2-dimensional, 3-dimensional, static, dynamic, etc.

Referring to FIG. 5, the nine possible training technology outcomes result from the process are electronic classroom synchronous (ECS), electronic classroom asynchronous (ECA), simulator resident (SR), web-based synchronous (WBS), video teletraining (VTT), stand-alone PC (PC), PC-sim field (PCSF), simulator field (SF), and web-based asynchronous (WBA).

In the embodiment described, the candidate technologies comprise distributed technologies and resident technologies. By example and not by way of limitation the distributed technologies include: video teletraining (VTT), Web-based training, Interactive multimedia instruction (IMI) on standalone personal computer, personal computer based simulation and simulation. The resident technologies include, electronic classroom, computer based simulation and simulation.

VTT provides instructor-led training between two or more remote sites. VTT uses a transmission network to deliver instruction from an originating site to remote locations using video and audio simultaneously. Selected training courses are transmitted from the originating site via a satellite link or a landline to the receiving sites. Trainees at the remote sites are able to see the instructor and to interact with the instructor and students at remote sites, either through audio only (for example, one-way video, two-way audio) or audio with video (for example, two-way video, two-way audio). VTT is appropriate when real-time, student-to-student interaction is necessary to achieve training goals. VTT transmission realizes a cost advantage when compared to transporting people from all over the country to one location for training.

Web-based training includes asynchronous and synchronous modes. In the asychrononous mode training courses are designed to mimic instruction mediated on a local computer by using HTML and hypertext/hyperlinks across the internet/intranet. Administration typically includes an on-line registration, and electronic testing, and feedback via Internet email. Courses which rely on commercial off the shelf web browsers or client packages as the user interface and interact with a single or series of host computers over a network. The source of the training materials resides on the network, and not on the client computer. Training material can be hosted on a network server, downloaded to a client computer, and executed locally off the network. Executable programs may be downloaded from either an FTP site, directly from a web page, or from a special client application. Administration and testing are performed off-line, but could be developed for on-line use.

Synchronous web-based training is training delivered via the internet/intranet with two-way communication that occurs with virtually no time delay, allowing participants (i.e., students, instructors, or facilitators) to respond in real time. Generally it includes tools supported by standards-based data, audio, and videoconferencing (e.g., whiteboard, application, sharing, and question and answer). Courses can also rely on commercial off the shelf web browsers or client packages as the user interface and interact with a single or series of host computers over a network. The source of the training materials resides on the network, not on the client computer.

IMI is computer-controlled training in which the learning experience is based on the interaction between the learner and the computer system. The user's decisions and inputs to determine the level, order, pace of instructional delivery, and forms of visual or aural outputs. IMI has historically been used to replace traditional classroom lectures and can be used for distance learning, complex applications that require CD-ROM delivery, or interactive courses delivered over the Internet. Levels of interactivity and sophistication can be selected to fit instructional goals and available resources. Category 1 IMI is defined as simple presentation. It is the lost category of IMI development. Category 1 IMI is a knowledge or familiarization lesson, in linear format (e.g. one idea followed by another idea), used mainly for introducing an idea or concept. Category 1 is further subdivided: Category 1A is a video presentation with minor text. Category 1B is a graphics presentation with minor text. With Category 1, the trainee has little control over what is seen (minimum trainee interactivity).

Simulation is used in training to replicate work conditions and allow students to practice their skills in realistic settings without affecting operational equipment or the work environment. Students learn how to manipulate a computer-controlled model that recreates actual job tasks such as equipment repair or provides role scenarios for developing decision-making skills. Simulation can be valuable for providing additional opportunities to practice response strategies; evaluating user's problem-solving skills; allowing compression of time; providing access to remote areas; allowing enhancement of conventional training techniques; providing realistic substitute for natural experiences; allowing monitoring and evaluation of user performance; relating input or change parameters to output or outcomes; and allowing formulation and testing of hypotheses in a “safe” environment. Simulation is performed on a “simulator.” A simulator is a training device that substitutes for, by emulation, the functions and environment of actual equipment or systems. Typically, a simulator includes any training device, machine, or apparatus that reproduces a desired condition or set of conditions synthetically. Specifically for training, a relatively complex item of training equipment, using electronic/mechanical means to reproduce conditions necessary for an individual, or a crew, to practice operational tasks in accordance with training objectives. The simulator represents the operational equipment physically and functionally to varying degrees and follows mathematical equations that describe performance.

A stand-alone PC is a self-contained computer system consisting of at least a central processor, central memory, display device, and input device and typically refers to a single-user, self-contained microcomputer system.

The electronic classroom is classified as either synchronous or asynchronous. Electronic classrooms are equipped to deliver curriculum materials in an electronic (paperless) format. An electronic classroom takes advantage of electronic data storage, communication and display technologies that permit new ways of creating and delivering classroom instruction. Asynchronous electronic classrooms provide an environment for computer-mediated instruction where each student controls the pace and order of lessons. The instructor typically uses a computer and large screen display to present text, graphics, animations, and video segments.

Asynchronous electronic classrooms include a networked personal computer for each student along with the enhanced instructor podium/electronic presentation system that also serves as the instructor's station on the network. Some configurations use the instructor station as the LAN server, and some include a separate LAN server. These classrooms can support both instructor led and individualized ICW, automated student progress testing and monitoring, remediation, and access for both instructor and student to IETMs. The asynchronous electronic classrooms provide instructors and students with an automated learning environment that has proven to shorten course lengths, results in improved comprehension, and allows hands-on experience with IETMs if the students will later encounter them.

Synchronous electronic classrooms are capable of supporting instructor led interactive presentations with instructor access to IETMs for presentation to the class. It supports computer-generated animations and full motion video segments in addition to presentation of static text and graphics. These classrooms gain an advantage over traditional instructor lecture utilizing transparencies when motion is necessary in the instructional presentation to facilitate student understanding (for example, to clarify concepts such as electron flow in a circuit, the flow of fluids in a hydraulic system, etc.) The assigned savings in class time resulting from animation and full motion video segments that instructional content/lessons requiring motion has been estimated to be in the range of 10-15%. A 5% advantage over presenting static text and graphics is assigned to the synchronous electronic classroom because changing the slides in the computer-generated slide show is quicker and easier to manage than “flipping” transparencies.

The electronic classroom is further defined to include two levels. At the introductory level (I-level), the instructor station includes a customized podium, computer, projection system, document camera, laser printer and two monitors. One monitor displays the lesson plan for the instructor while the second displays the multimedia being projected to the class. Student workstations include wireless response keypad systems that can display and record “Yes/No” and alphanumeric responses from each student station. The I-Level electronic classroom is most appropriate where courses include multimedia presentations, and where responding to the instructor rather than interacting with the displayed material via computer can effectively achieve student interaction. Course materials can include live motion, graphics, animations, interactive electronic technical manuals, instructor-led interactive courseware, and other interactive multimedia instructional products. The instructor from his podium manages the projection system remotely. The projector is a high power/high resolution product that is well know commercially and is usually mounted in ceiling brackets.

At the advanced level the electronic classroom incorporates an instructor station that includes a customized podium, computer, projection system, document camera, laser printer and two monitors. Students are provided with individual computer workstations that include a computer and monitor and are linked to a classroom server. The advanced level electronic classroom becomes most appropriate for courses where students need to interact by computer with the course material. Course materials can include live motion, graphics, animations, interactive electronic technical manuals, interactive courseware, and other interactive multimedia instruction products. An audio/video switching system allows the communication with each student. The instructor from his or her podium manages the projection system remotely. The projector is a high power/high resolution commercial product that is typically mounted in ceiling brackets.

Phase II Economic Analysis of Technology Alternatives

Referring again to FIG. 2, phase II the economic analysis of alternative training delivery technology solutions is shown at 30. Additional questions 32 are answered thereby applying cost logic 34 to provide candidate technology selection and cost results 36. After a set of solutions has been calculated, further input 38 is allowed in blend analysis logic 40. The blend analysis permits the program developer to mix the candidate technologies to determine the optimal mix of training technologies given available resources.

Referring to FIG. 6, the phase II questions of the illustrated embodiment are disclosed along with guidance for answering the questions. The phase two questions along with questions previously identified hereinabove are provided to the phase II logic.

Referring to FIGS. 7,8,9,10,11,12 and 13, the formulae of the one embodiment and their relationship within the phase II analysis is illustrated. The economic analysis requires an assessment of both the cost of the resources required to support each alternative and an assessment of the benefits in units of cost avoidance or savings derived from each alternative being considered. For those alternatives that can be implemented, the return on investment for each delivery alternative is compared before the selection of the best delivery alternative is made.

Training efficiency is the comparison of the costs and benefits of a training technology alternative. Training efficiency is the primary consideration in phase II.

The cost of each training delivery technology alternative is analyzed in terms of investment costs and annual recurring costs. The benefits are the savings resulting from using a particular technology to accomplish specific training goals that are quantified by estimating the costs attributed to implementing the current training delivery that would be eliminated or reduced by implementing the technology alternative. The return on investment and benefit/cost ration are provided for each technology alternative.

Referring to FIG. 14, the formulae for the blend analysis are illustrated. The blend analysis provides the user to change assumptions, technology solution allocations and other data to modify the results of the baseline analysis determined by the logic.

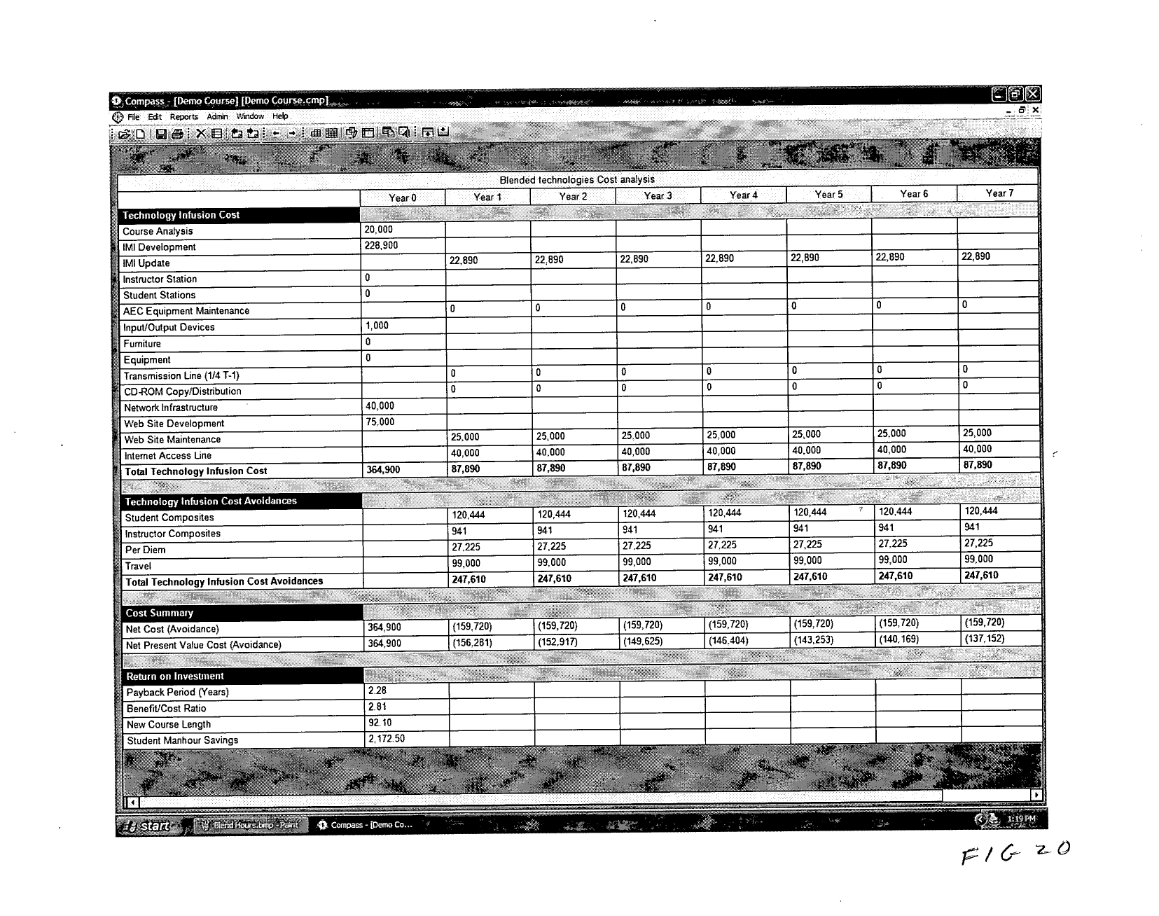

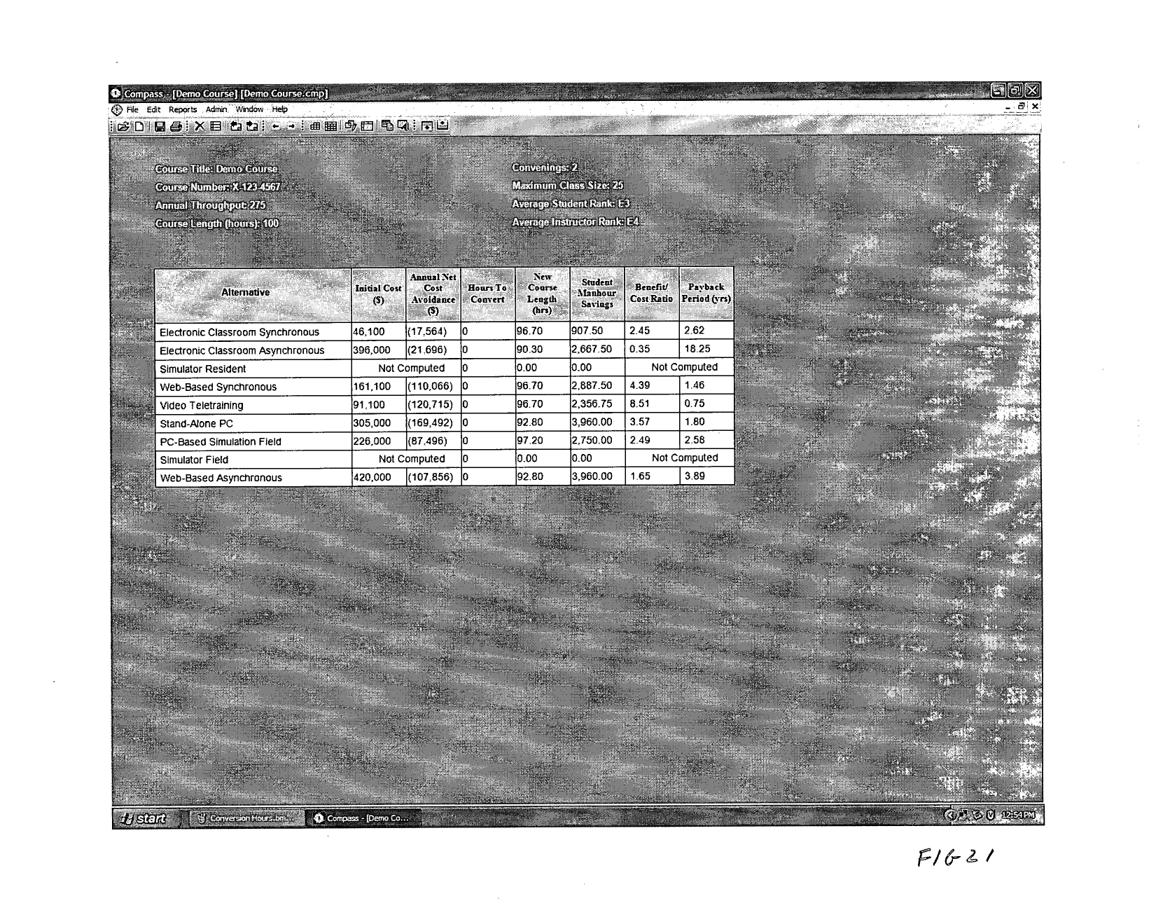

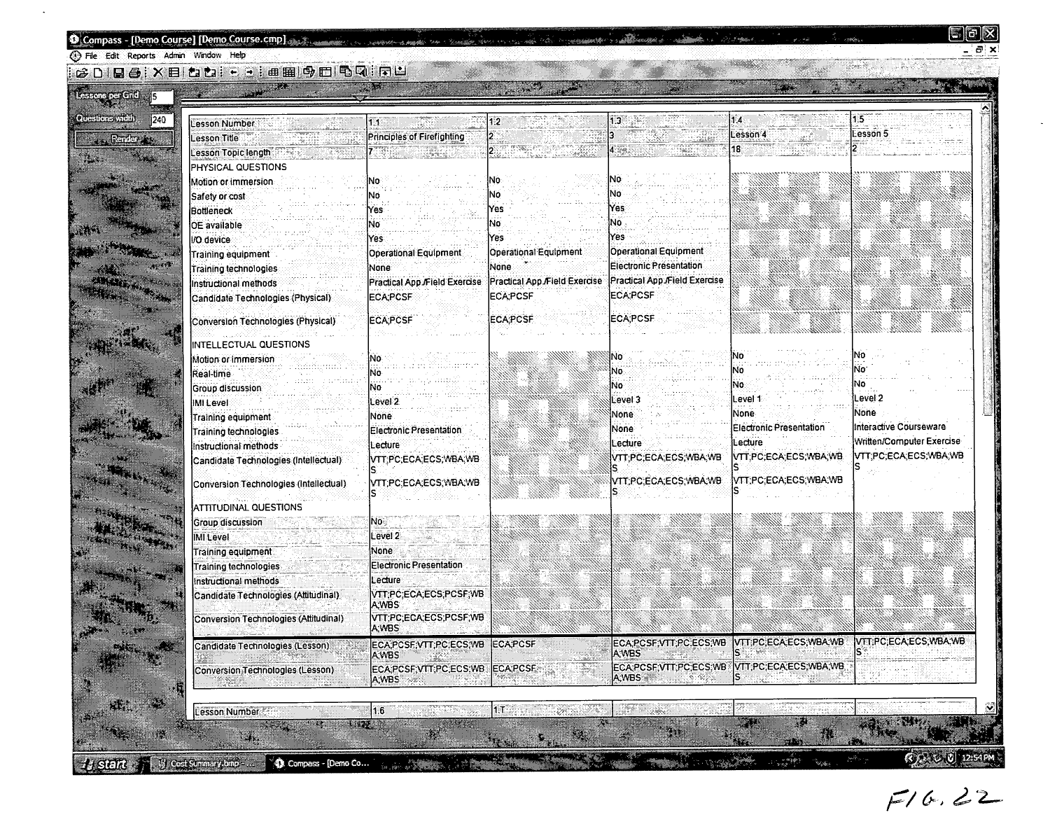

Referring to FIG. 15 through 22 the operation of the invention will now be explained. In operation, the invention resides on a personal computer with screen displays provided to enable the user to conduct the analysis of training technologies through the analysis in a logical progression. A user opens an analysis from the entry screen FIG. 15 by entering information into the displayed fields. Next, the analysis is performed for each lesson title beginning on the next screen FIG. 16, Sh. 1-4. Questions are presented and answered through a drop down menu arrangement. In FIG. 17, questioning continues to complete the data entry for the phase II analysis. The program computes the results and presents the results in several screen formats as shown in FIG. 18, Sh. 1-7. The user has the ability to change the results to perform sensitivity analyses through the blended analysis logic using screens shown in FIG. 19-21. Summary reports are also available such as the one shown in FIG. 22.

While preferred embodiments have been shown and described, various modifications and substitutions may be made thereto without departing from the spirit and scope of the present invention. Accordingly, it is to be understood that the present invention has been described by way of illustrations and not limitation.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

What is claimed is:

1. A computer program for selecting one or more training technologies comprising:
training performance attribute queries for determining the performance attributes of the training;
training technology selection logic for selecting the training technology to perform the training, the selected training technology meeting or exceeding the training performance attributes of the training;
cost queries for determining the cost of implementing the training technology;
cost logic for calculating the cost of the training technology; and,
a blended analysis for performing sensitivity studies.

2. The computer program of claim 1 wherein the selected training technology is a training technology selected from the group consisting of electronic classroom synchronous, electronic classroom asynchronous, simulator resident, web-based synchronous, video teletraining, stand-alone PC, PC-based simulation field, simulator field or web-based asynchronous.

3. The computer program of claim 1 wherein the performance attribute queries for determining the performance attributes comprise intellectual skills, physical skills and attitudinal skills.

4. The computer program of claim 1 wherein the number of training performance attribute queries is at least nine.

5. The computer program of claim 1 wherein the training performance queries are in the form of binary responses.

6. The computer program of claim 1 wherein the cost logic for calculating the cost of the training includes present costs, life cycle costs, salary costs, transportation costs of the attendees and living costs of the attendees.

7. The computer program of claim 6 wherein the present costs include conversion costs from an existing training technology.

8. A method of selecting a training technology comprising:
displaying training performance attribute queries for determining the performance attributes of the training;
responding to the training performance attribute queries for determining the performance attributes of the training;
applying training technology selection logic for selecting the training technology to perform the training, the selected training technology meeting or exceeding the training performance attributes of the training;
displaying cost queries for determining the cost of implementing the training technology;
responding to the cost queries for determining the cost of implementing the training technology;
applying a cost logic for calculating the cost of the training technology; and,
performing a blended analysis for performing sensitivity studies.

9. The method of claim 7 wherein the selected training technology is a training technology selected from the group consisting of electronic classroom synchronous, electronic classroom asynchronous, simulator resident, web-based synchronous, video teletraining, stand-alone PC, PC-based simulation field, simulator field or web-based asynchronous and the performance attribute queries for determining the performance attributes comprise intellectual skills, physical skills and attitudinal skills.

10. A training technology selection tool comprising:
means for determining the performance attributes of the training;
means for training technology selection to perform the training, the selected training technology meeting or exceeding the training performance attributes of the training;
means for determining the cost of implementing the training technology;
means for calculating the cost of the training technology; and,
means for performing sensitivity studies.

11. The training technology selection tool of claim 9 wherein the means for determining the performance attributes of the training includes the use of drop down menus displayed on a personal computer screen.
